(19) United States
(12) Patent Application Publication
(10) Pub. No.: US 2026/0350413 A1
(43) Pub. Date: Nov. 5, 2026

(54) GOLDEN-RATIO RESONANCE REGULARIZER FOR SELF-SIMILAR SCALE ORGANIZATION IN MACHINE-LEARNING MODEL

(71) Applicant: Jonathan Washburn, Austin, TX (US)

(72) Inventor: Jonathan Washburn, Austin, TX (US)

(21) Appl. No.: 19/662,999

(22) Filed: Apr. 29, 2026

Related U.S. Application Data
(60) Provisional application No. 63/797,342, filed on Apr. 30, 2025.

(51) Int. Cl. G06N 3/096; G06N 3/0464

(52) U.S. Cl. CPC G06N 3/096; G06N 3/0464

(57) ABSTRACT

A machine-learning regularization method and system are disclosed. Characteristic scales are extracted from one or more model tensors, adjacent scale ratios are compared to a golden-ratio target phi, and deviations are weighted according to ladder position on a phi-ladder. A regularization penalty is computed from the weighted deviations and incorporated with a task loss during training. In a canonical embodiment, the penalty uses fixed coupling X_opt=phi/pi and is added without a tunable scalar coefficient. Characteristic scales may be extracted from FFT-based spectra, attention distributions, graph Laplacian eigenvalues, wavelet channels, or other tensor-derived structures. The regularizer may be implemented in software, on a non-transitory computer-readable medium, or in hardware-assisted embodiments, and may be integrated into existing training workflows to encourage self-similar scale organization in learned representations.

### CROSS-REFERENCE TO RELATED APPLICATIONS

This application claims priority to U.S. Provisional Patent Application No. 63/797,342, filed Apr. 30, 2025, the disclosure of which is incorporated herein by reference in its entirety.

### BACKGROUND

The present disclosure relates to machine-learning regularization and training methods and, more particularly, to methods and systems for extracting characteristic scales from model tensors and applying a phi-anchored weighted penalty to encourage self-similar scale organization during training. The disclosure further relates to scale-aware and structure-aware training objectives, software modules and non-transitory media for implementing such objectives, and optional hardware-accelerated embodiments for evaluating such objectives. The invention is not limited to a single model class, but it is also not an abstract theory of scale in all systems. Rather, the invention concerns a concrete training regularizer acting on extracted characteristic scales from model tensors.

Existing regularization techniques can improve generalization or stabilize optimization, but they are generally structure-blind with respect to the spacing of learned characteristic scales. For example, L1 regularization can promote sparsity, L2 regularization can shrink weights, dropout can suppress co-adaptation, spectral normalization can constrain singular-value growth, and batch normalization can normalize activations. However, such techniques do not directly enforce self-similar feature spacing, scale-invariant receptive-field organization, or golden-ratio hierarchy in learned representations. As a result, conventional training procedures can produce arbitrary or weakly organized multiscale structure even in settings where the underlying data exhibit strong scale hierarchy.

Multiscale structure is common across many classes of input data and learned representations. Images can exhibit hierarchical organization extending from edges to textures to objects and scenes. Sequential and language data can exhibit meaningful span structure across multiple token ranges. Biological and genomic data can exhibit periodic or ladder-related organization across multiple operative lengths. Graph and molecular data can exhibit informative spectral structure across multiple scales. In such settings, a model that learns features on an organized multiscale ladder can capture underlying structure more efficiently than a model whose learned scales are arbitrarily spaced.

Within the disclosed self-similar framework, phi is not an arbitrary choice. Rather, self-similarity forces the fixed-point relation x\hat{ }2=x+1, yielding phi=(1+sqrt(5))/2 as the unique positive fixed point. Accordingly, the disclosed regularization target is a phi-ladder in which characteristic scales are organized with adjacent ratios equal to phi. In this framework, the role of the regularizer is to drive extracted characteristic scales toward that ladder during training rather than merely to shrink weights or suppress activations in a scale-agnostic manner.

There therefore remains a need for a machine-learning regularizer that acts on characteristic scales rather than only on raw weight magnitude, drives learned scales toward a self-similar ladder, can be integrated into existing training loops, supports differentiable training, can be instantiated across multiple model architectures, and avoids requiring an additional user-tuned regularization coefficient in its canonical form. There also remains a need for such a regularizer to be implemented in a manner compatible with software libraries, training frameworks, and optional hardware acceleration without requiring redesign of the underlying model architecture.

The present disclosure addresses these needs by providing a regularization mechanism in which a sequence of characteristic scales is extracted from one or more model tensors, adjacent ratios of those scales are compared to phi, deviations are weighted according to ladder position on a phi-ladder, and a resulting penalty is incorporated into training. In the canonical embodiment disclosed herein, the penalty is added directly to task loss with fixed coupling X_opt=phi/pi, and no tunable scalar coefficient multiplying the penalty is required. The disclosed kernel, extraction paths, implementation details, and validation material provide a make-and-use disclosure for a broad but disciplined non-provisional application.

### SUMMARY

The present disclosure provides a machine-learning training method and system in which characteristic scales are extracted from one or more model tensors, adjacent ratios of those scales are compared to phi, deviations are weighted according to ladder position on a phi-ladder, and a resulting regularization penalty is incorporated into training to drive learned representations toward self-similar scale organization. The disclosed regularizer is directed to scale structure rather than merely to magnitude suppression and can be integrated into existing training workflows across multiple model architectures.

In the canonical embodiment, the regularizer is defined using an ordered sequence of characteristic scales f_k, a ratio-error term e_k=f_(k+1)/f_k−phi, a ladder coordinate rho_k=log_phi(f_k/f_0), and a weighting term w_k=phi\hat{ }(−rho_k). A regularization penalty is computed as R_phi=(phi/pi)×(1/(K−1))×sum_k (w_k×e_k\hat{ }2), and a total loss is defined as L=L_task +R_phi. In this canonical embodiment, X_opt=phi/pi, and no tunable scalar coefficient multiplies R_phi. Phi is not treated as an arbitrary selected constant within the disclosed framework, but as the unique positive fixed point of the disclosed self-similar relation.

More specifically, within the disclosed self-similar relation x\hat{ }2=x+1, phi=(1+sqrt(5))/2 is the unique positive fixed point, and the disclosed regularizer is therefore constructed to drive learned characteristic scales toward a phi-ladder rather than toward an arbitrary spacing target.

The disclosed penalty is non-negative and is structured so that R_phi=0 iff all consecutive extracted scale ratios equal phi. The global minimum of R_phi is therefore the phi-ladder. In preferred embodiments, the weighting is continuous through rho_k, permitting a differentiable or almost-everywhere differentiable implementation compatible with gradient-based training and backpropagation. In optional embodiments, a quantized rung index m_k=floor(rho_k) is used, with weighting w_k=phi\hat{ }(−m_k). The quantized embodiment can be useful in discrete, quantized, or hardware-oriented implementations and may use straight-through or stop-gradient treatment where appropriate.

Characteristic scales can be extracted from different model structures in different embodiments. In such embodiments, the FFT-based, attention-based, graph-spectral, and wavelet-based extraction paths are alternative front-end mechanisms that provide an ordered characteristic-scale sequence to a shared penalty-computation kernel.

In a convolutional-neural-network embodiment, characteristic scales can be derived from an FFT-based power spectrum of weights, activations, or both, optionally using candidate-peak selection and local soft-peak refinement. In a transformer embodiment, characteristic scales can be derived from attention distributions, including expected token spans or attention radii. In a graph embodiment, characteristic scales can be derived from one or more non-zero eigenvalues of a graph Laplacian. In a wavelet embodiment, characteristic scales can be derived from channel center scales. Optional embodiments also include temporal regularization, inter-layer regularization, volumetric regularization, pruning-aware verification, and a Fibonacci-sequence-based alternative branch.

The disclosed regularizer can be implemented as a software module, a regularization library, a framework-integrated callback or training component, a non-transitory computer-readable medium storing instructions for performing the disclosed operations, or an optional hardware-accelerated architecture. In a reference implementation, the regularizer is added to a training loop without requiring modification of the underlying model architecture, optimizer, or data loader. The regularizer can also be used additively with other regularizers. Optional hardware-oriented embodiments include GPU execution, FPGA-assisted computation, and, in some implementations, instruction-level or interface-level support in specialized neural-processing hardware. Such hardware-oriented embodiments are implementation pathways for evaluating or applying the disclosed regularizer and are not required for practicing the core invention.

Reported performance values, overhead values, ratio-error values, scale-organization outcomes, and acceptance thresholds described herein should be understood as benchmark-specific, validation-oriented, or configuration-dependent unless expressly stated otherwise, and are not presented as universal guarantees for every implementation.

Machine-checked support is provided for properties including weight positivity, weight decay with ladder position, non-negativity of penalty terms, zero-iff-phi behavior of the ratio term, and coupling from phi. Benchmark and validation material further support use of the disclosed regularizer in image classification, language-model span organization, and genomic feature discovery, while downstream embodiments include interpretable feature learning, edge-AI deployment, attention-head analysis, detector-event data reduction, and molecular property prediction.

These downstream embodiments remain subordinate to the core regularization mechanism, which is defined by extracted characteristic scales, phi-ratio deviation, ladder-position-dependent weighting, and training-time penalty incorporation.

### BRIEF DESCRIPTION OF THE DRAWINGS

FIG. 1 is a block diagram of an overall machine-learning training system configured to receive input data, extract characteristic scales from one or more model tensors, compute a phi-anchored regularization penalty, combine the regularization penalty with a task loss, and update model parameters.

FIG. 2 is a diagram of a penalty-computation kernel in which an ordered characteristic-scale sequence is transformed into ratio-error values, ladder coordinates, continuous or quantized ladder weights, an aggregated regularization penalty, and a combined loss.

FIG. 3 is a diagram of a convolutional-neural-network embodiment in which characteristic scales are extracted from a filter, activation trace, or related tensor-derived structure using an FFT-based power spectrum and localized peak estimation.

FIG. 4 is a diagram of a transformer embodiment in which characteristic scales are extracted from attention behavior, including expected token spans or attention radii derived from attention distributions.

FIG. 5 is a diagram of graph and wavelet embodiments in which characteristic scales are extracted from non-zero graph Laplacian eigenvalues or from wavelet center scales and are provided to a shared regularization pathway.

FIG. 6 is a flow diagram of a training-loop integration embodiment showing a forward pass, task-loss computation, tensor selection, regularization-penalty computation, loss combination, backward propagation, and parameter update.

FIG. 7 is a diagram of optional and alternative embodiments including inter-layer scale regularization, temporal regularization, volumetric regularization, pruning-aware verification, and a Fibonacci-sequence-based alternative penalty branch.

FIG. 8 is a diagram of software and hardware implementation embodiments including a regularization library, framework integration, CPU or GPU execution, FPGA-assisted computation, memory or buffer support, and an optional NPU-oriented execution path.

FIG. 9 is a diagram of a benchmark and validation workflow for comparing baseline training and disclosed regularizer-enabled training using ratio-error measurement, task-performance measurement, scale visualization, overhead measurement, and acceptance criteria.

FIG. 10 is a diagram of a formal-verification and evidence architecture showing a relationship among mathematical definitions, machine-checked regularizer properties, benchmark evidence, and disclosure-support structures.

### DETAILED DESCRIPTION

The present disclosure provides a machine-learning regularizer that acts on characteristic scales extracted from one or more model tensors and drives those scales toward a self-similar phi-ladder during training. The regularizer is directed to scale organization rather than merely to suppression of parameter magnitude. By operating on tensor-derived characteristic scales and integrating the penalty into the training loop, the disclosed regularizer improves training-time scale organization of learned representations in a manner that is not achieved by magnitude-only regularization. In the disclosed framework, phi is not an arbitrary selected constant, but the unique positive fixed point of the disclosed self-similar relation. Accordingly, the regularizer measures deviation from phi-spaced scale organization and penalizes such deviation in a weighted manner during training.

The core regularization mechanism operates by extracting a sequence of characteristic scales from one or more tensors associated with a machine-learning model, comparing adjacent ratios of those scales to phi, weighting the resulting deviations according to ladder position on a phi-ladder, and incorporating a resulting penalty into model training. In the canonical embodiment, the penalty is added directly to task loss with fixed coupling X_opt=phi/pi, and no tunable scalar coefficient multiplying the penalty is required. This canonical posture is maintained throughout the present disclosure, while preferred, optional, alternative, downstream, and prophetic embodiments are separately described without displacing the core regularization mechanism.

For purposes of the present disclosure, a “characteristic scale” is a machine-extracted quantity representing an operative scale of model behavior or structure. Depending on implementation, a characteristic scale can correspond to, for example, a characteristic frequency, receptive-field extent, token span, attention radius, graph spectral quantity, center scale, temporal scale, volumetric spatial frequency, or another tensor-derived scale descriptor. A “model tensor” includes, without limitation, an activation tensor, a weight tensor, an attention tensor, an embedding tensor, or another tensor-derived structure from which one or more characteristic scales can be extracted.

A “phi-ladder” is an ordered self-similar scale hierarchy in which adjacent scale ratios are equal or tend toward phi. In preferred embodiments, a sequence of characteristic scales is ordered in ascending form so that adjacent ratios are well-defined. In exemplary implementations, the extracted scales are conditioned to remain positive, such as by excluding a direct-current bin, adding a small positive epsilon, using a strictly positive estimator, or otherwise preventing zero-valued scale entries. In preferred implementations, the smallest extracted characteristic scale is designated as f_0 for ladder-coordinate computation.

In the disclosed kernel, if an ordered sequence of characteristic scales is represented as f_k, adjacent ratio error is computed as:

e_k=f_(k+1)/f_k−phi.

A continuous ladder coordinate is computed as:

rho_k=log_phi(f_k/f_0).

As used herein, log_phi(x) denotes the logarithm of x in base phi, i.e., log_phi(x)=ln(x)/ln(phi) for x>0, where ln(⋅) is the natural logarithm. As used herein, pi denotes the circle constant. The constant phi denotes the golden ratio (1+sqrt(5))/2.

In a preferred continuous embodiment, weighting is computed as:

w_k=phi\hat{ }(−rho_k).

In the disclosed weighting structure, higher-rung or higher-frequency scales receive smaller weights, thereby preserving a hierarchy in which lower-rung or larger-scale structure is weighted more strongly than finer-scale detail. This reproduces the disclosed ladder-weighting hierarchy in which large-scale structure is given greater recognition significance than higher-frequency detail.

A regularization penalty is then computed as:

R_phi=X_opt*(1/(K−1))*sum_k (w_k*e_k\hat{ }2),

and, in the canonical embodiment:

X_opt=phi/pi.

In one implementation, the aggregation sum_k is evaluated over adjacent pairs of the ordered scales, e.g., for k=0 to K−2, and the normalization term 1/(K−1) averages across those adjacent pairs.

The total loss is then given by:

L=L_task+R_phi,

where L_task is a task loss associated with the training objective. In this canonical embodiment, no additional tunable scalar coefficient multiplies R_phi.

The disclosed penalty is non-negative because it is formed from weighted squared ratio-error terms. In the disclosed framework, the penalty equals zero if and only if all consecutive extracted scale ratios equal phi, and the global minimum of the penalty is the phi-ladder. In preferred continuous embodiments, the regularizer is differentiable or differentiable almost everywhere with respect to model parameters, permitting use with backpropagation and gradient-based optimization. In optional quantized embodiments, a quantized rung index can be used in place of the continuous ladder coordinate. In one such embodiment:

m_k=floor(rho_k),

and weighting is computed as:

w_k=phi\hat{ }(−m_k).

In such quantized embodiments, gradient handling can be implemented using straight-through estimation, stop-gradient handling, or another discrete-compatible training treatment.

The disclosed regularizer can be integrated into a training workflow at one or more locations in a machine-learning model. The disclosed regularizer can therefore be instantiated across convolutional, transformer, graph-neural-network, wavelet-based, temporal, recurrent, and volumetric model families, provided that one or more characteristic scales can be extracted from model tensors and ordered for use in the disclosed penalty computation. In some embodiments, characteristic scales are extracted from convolutional filters or associated activations. In some embodiments, characteristic scales are extracted from attention behavior in a transformer architecture. In some embodiments, characteristic scales are extracted from graph spectral structure, wavelet channels, temporal channels, inter-layer relationships, or volumetric data representations. These embodiments are described below, but do not alter the identity of the core regularization mechanism, which remains the computation of a phi-anchored weighted penalty from extracted characteristic scales and the incorporation of that penalty into training.

The disclosed regularizer can be embodied as software instructions executed on one or more processors, as a regularization library, as a module integrated into a training framework, as a non-transitory computer-readable medium storing executable instructions, or, in optional embodiments, as a hardware-accelerated implementation. The disclosed regularizer can be used additively with other regularizers and can be incorporated into an existing training loop without requiring a change to the underlying model architecture, optimizer, or data loader.

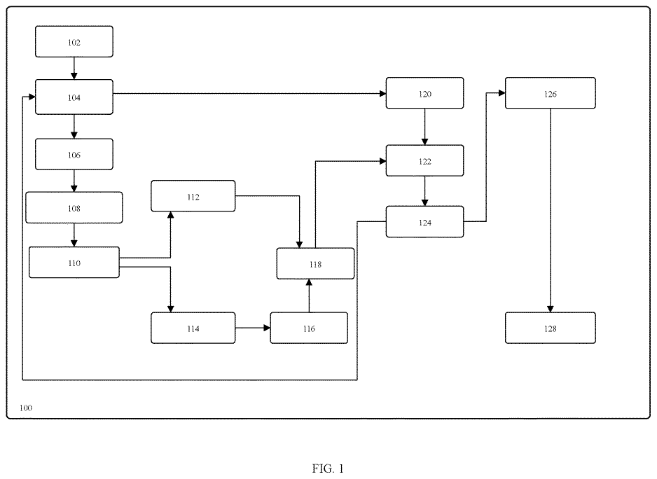

The figures are described sequentially below. FIG. 1 first introduces an overall training architecture in which model tensors are tapped during training, characteristic scales are extracted, a phi-anchored regularization penalty is computed, and model parameters are updated using a combined loss.

FIG. 1 depicts an overall training system 100 configured to train a machine-learning model using a phi-anchored regularization penalty derived from characteristic scales extracted from one or more model tensors. The system 100 receives input data 102 and provides the input data 102 to a machine-learning model 104. The machine-learning model 104 can be any trainable model from which one or more tensors can be selected during training, including, for example, a convolutional-neural-network model, a transformer model, a graph-neural-network model, a wavelet-based model, a recurrent model, a temporal model, or another trainable architecture having tensors from which characteristic scales can be extracted.

During training, one or more selected model tensors 106 are provided from the machine-learning model 104 to a scale-extraction engine 108. The selected model tensors 106 can include, without limitation, activation tensors, weight tensors, attention tensors, embedding tensors, feature maps, graph-derived tensors, or other tensor-derived structures. The scale-extraction engine 108 processes the selected model tensors 106 and produces ordered characteristic scales 110. In preferred embodiments, the characteristic scales are positive and are ordered in ascending form before being supplied to a ratio-error engine 112 and a ladder-coordinate engine 114.

The ratio-error engine 112 computes phi-referenced ratio deviations using adjacent ordered characteristic scales. In one embodiment, the ratio-error engine 112 computes:

e_k=f_(k+1)/f_k−phi,

for one or more adjacent scale pairs. The ladder-coordinate engine 114 computes ladder position relative to a baseline scale f_0. In one embodiment, the ladder-coordinate engine 114 computes:

rho_k=log_phi(f_k/f_0),

where f_0 is the smallest extracted characteristic scale. A weighting engine 116 then computes ladder-position-dependent weighting values. In a preferred continuous embodiment, the weighting engine 116 computes:

w_k=phi\hat{ }(−rho_k).

In an optional quantized embodiment, the weighting engine 116 can instead operate on a quantized rung index m_k, where:

m_k=floor(rho_k),

and can compute:

w_k=phi\hat{ }(−m_k).

A penalty engine 118 receives the ratio-error values and weighting values and computes a phi-anchored regularization penalty. In the canonical embodiment, the penalty engine 118 computes:

R_phi=X_opt×(1/(K−1))×sum_k (w_k×e_k\hat{ }2),

where:

X_opt=phi/pi.

A task-loss engine 120 computes a task loss associated with the training objective of the machine-learning model 104. A loss-combination engine 122 combines the task loss with the regularization penalty to produce a total loss. In the canonical embodiment, the loss-combination engine 122 computes:

L=L_task+R_phi.

In this canonical embodiment, no tunable scalar coefficient multiplying R_phi is required. This architecture thereby differs from conventional regularization frameworks in which a user-selected coefficient must be tuned independently of the disclosed kernel.

A parameter-update engine 124 receives the combined loss and updates parameters of the machine-learning model 104 to produce an updated model 126. In preferred embodiments, the penalty is incorporated into gradient-based optimization and backpropagation. In some embodiments, the regularization penalty is evaluated during each training batch, mini-batch, epoch, or selected training interval. In some embodiments, regularization can be applied at one or more selected layers, heads, channels, graph-processing stages, or tensor tap points within the machine-learning model 104.

The overall training system 100 can optionally generate an output report 128. The output report 128 can include, for example, extracted characteristic scales, ratio-error values, ladder-coordinate values, penalty values, validation results, visualizations of learned scale organization, performance metrics, overhead measurements, or another machine-generated output associated with the disclosed training process. In some embodiments, the output report 128 is used for validation, auditing, model comparison, architecture selection, pruning verification, or downstream interpretation. Such outputs remain subordinate to the core invention, which is the training-time regularization mechanism itself.

FIG. 1 therefore illustrates the high-level structure of a training architecture in which the disclosed phi-anchored regularization mechanism is integrated into the training path of a model. The architecture shown in FIG. 1 is intentionally model-agnostic at the system level, while the specific mechanisms for extracting characteristic scales in different architectures are disclosed in later figures and accompanying description.

In some implementations corresponding to FIG. 1, the scale-extraction engine 108 can operate on a single selected tensor. In some implementations, the scale-extraction engine 108 can aggregate information from multiple tensors. In some implementations, different tensor classes are processed by different extraction branches before being normalized into a common ordered characteristic-scale sequence. In some implementations, the ratio-error engine 112, ladder-coordinate engine 114, weighting engine 116, and penalty engine 118 are implemented as distinct software modules. In some implementations, two or more of those functions are combined into a shared computational module, library function, or hardware-supported path. The illustrated separation is therefore functional and need not require a one-to-one mapping to independently deployed software binaries or physical devices.

Any “engine,” “module,” or “component” described herein may be implemented by one or more processors and one or more memories storing instructions that, when executed, cause the processors to perform the described operations; by dedicated circuitry; or by a combination thereof.

In preferred implementations, the ordered characteristic scales 110 are constructed so that K is at least 2, each scale is positive, and the sequence is ordered before penalty computation. In some embodiments, candidate scales having equal or near-equal values can be handled using deterministic ordering logic, stable sort behavior, tie-breaking based on source index, tie-breaking based on magnitude or confidence, or another deterministic policy. In some embodiments, small positive conditioning values can be introduced to avoid division by zero or undefined logarithmic operations. Such implementation details can be used to improve reproducibility and robustness without changing the core regularization kernel.

The architecture of FIG. 1 also supports additive compatibility with other regularization procedures. In some embodiments, the disclosed regularizer is used alone. In some embodiments, the disclosed regularizer is used together with one or more additional regularizers, such as weight decay, dropout, spectral regularization, norm constraints, or related techniques. In such embodiments, the disclosed phi-anchored penalty remains a distinct term computed from characteristic-scale structure rather than from raw parameter magnitude alone.

The functional arrangement shown in FIG. 1 illustrates that the disclosed regularizer can be embodied as a training method, as a system architecture, or as software instructions stored on a non-transitory computer-readable medium. More specific extraction paths, weighting variants, architecture-specific embodiments, hardware embodiments, and downstream application embodiments can be layered on top of the FIG. 1 architecture without changing the identity of the core invention.

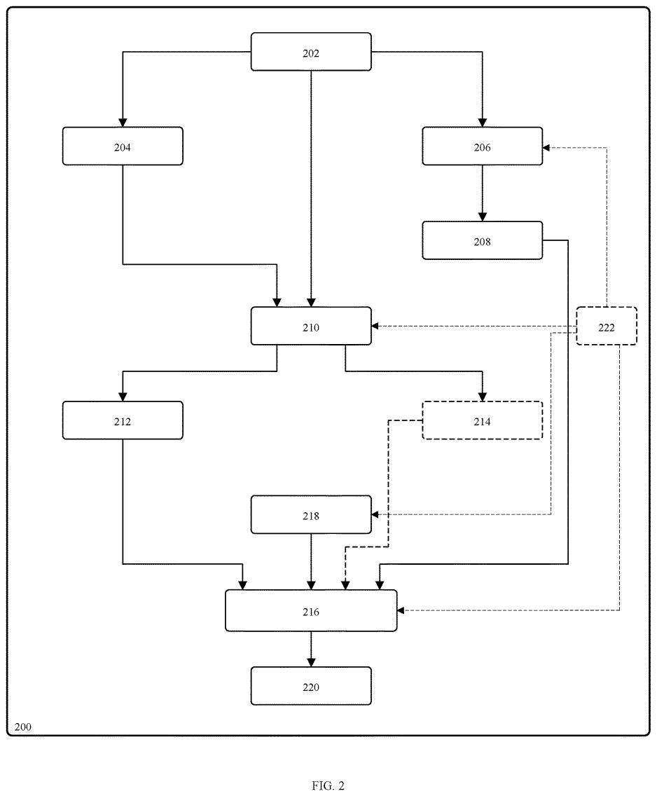

The detailed computation path for the disclosed regularization penalty is described next with reference to FIG. 2, which isolates the mathematical kernel from architecture-specific scale extraction.

FIG. 2 depicts a penalty-computation system 200 that isolates the determinative regularization kernel from architecture-specific scale extraction. The penalty-computation system 200 receives a scale sequence 202 comprising an ordered set of characteristic scales f_k derived from one or more model tensors. A baseline scale selector 204 identifies a baseline scale f_0 from the scale sequence 202. In preferred embodiments, the baseline scale selector 204 selects the smallest extracted characteristic scale as f_0, thereby fixing a reference point for ladder-coordinate computation.

A ratio computation module 206 receives adjacent scale values from the scale sequence 202 and computes ratio-error outputs 208 relative to phi. In one embodiment, the ratio computation module 206 computes:

e_k=f_(k+1)/f_k−phi

for one or more adjacent ordered scale pairs. The ratio-error outputs 208 therefore represent departures of local scale spacing from the phi-ladder target. If consecutive extracted characteristic scales are spaced by phi, the corresponding ratio-error term is zero. If the spacing departs from phi, the corresponding term is non-zero and contributes to the regularization penalty.

A ladder-coordinate module 210 computes ladder position for one or more extracted scales relative to the baseline scale f_0. In one embodiment, the ladder-coordinate module 210 computes:

rho_k=log_phi(f_k/f_0).

The ladder coordinate rho_k indicates where the corresponding scale sits on the disclosed phi-ladder. In preferred embodiments, rho_k is treated as a continuous quantity, allowing the disclosed weighting logic to vary smoothly across ladder position. In optional embodiments, the ladder-coordinate module 210 also supports quantization of ladder position into integer or integer-like rungs.

A continuous weighting module 212 receives one or more ladder coordinates and computes weighting values according to ladder position. In a preferred continuous embodiment, the continuous weighting module 212 computes:

w_k=phi\hat{ }(−rho_k).

This weighting structure causes weights to decay with ladder position so that scales located farther along the ladder can be weighted differently from lower-rung scales. The disclosed weighting logic is part of the core regularization mechanism and should not be reduced to a generic “weighted loss” abstraction. Rather, the weighting is expressly tied to the disclosed phi-ladder coordinate system.

An optional quantized-rung module 214 is provided for embodiments in which ladder position is quantized. In one embodiment, the optional quantized-rung module 214 computes:

m_k=floor(rho_k),

and the weighting can then be computed as:

w_k=phi\hat{ }(−m_k).

The quantized-rung branch is optional and does not replace the preferred continuous branch. Instead, it provides an additional embodiment that can be useful in discrete, quantized, or hardware-oriented implementations. In some embodiments, the continuous weighting module 212 and the optional quantized-rung module 214 are both available within the same implementation, allowing an implementation to switch between or compare continuous and quantized ladder treatment.

A penalty aggregation module 216 receives the ratio-error outputs 208 and one or more weighting values from the continuous weighting module 212 or the optional quantized-rung module 214. The penalty aggregation module 216 computes the disclosed regularization penalty. In the canonical embodiment, the penalty aggregation module 216 computes:

R_phi=X_opt×(1/(K−1))×sum_k (w_k×e_k\hat{ }2),

where K is the number of extracted characteristic scales in the sequence and K is at least 2. The normalization factor (1/(K−1)) provides a normalized aggregate across adjacent ratios, although other aggregation arrangements such as equivalent averaged or summed representations can be used so long as they preserve the disclosed weighted phi-ratio penalty structure.

A canonical coupling module 218 supplies the fixed canonical coupling used in the preferred kernel. In the canonical embodiment:

X_opt=phi/pi.

The disclosed canonical coupling is not presented as an arbitrary tuned hyperparameter. Rather, within the disclosed framework, it is fixed and is used directly in the penalty computation. In the canonical embodiment, no tunable scalar coefficient multiplying R_phi is required. This canonical posture should be maintained as an affirmative feature of the invention rather than softened into a merely optional implementation preference.

The output of the penalty aggregation module 216 is provided as a total-loss output 220, which represents the combined training objective when the regularization penalty is added to a task loss. In the canonical embodiment:

L=L_task+R_phi.

Accordingly, the penalty-computation system 200 provides a direct route from extracted characteristic-scale structure to the total training loss used for parameter update. This architecture is distinct from approaches that use ad hoc or separately tuned regularization multipliers because the disclosed canonical coupling is part of the disclosed kernel itself.

A property and verification block 222 represents the disclosed mathematical and formal-support properties associated with the penalty-computation system 200. In the disclosed framework, the penalty is non-negative. The penalty equals zero if and only if all consecutive scale ratios equal phi. The global minimum of the penalty is the phi-ladder. The disclosed source materials further provide machine-checked support for weight positivity, weight decay with ladder position, non-negativity of terms, zero-iff-phi behavior, and coupling from phi. These support properties reinforce the determinative nature of the disclosed kernel while remaining supportive evidence rather than claim limitations requiring proof execution during use.

FIG. 2 therefore isolates the core computational logic of the invention from any one architecture-specific extraction pathway. Whether characteristic scales originate from an FFT-based spectrum, an attention-radius estimator, a graph-Laplacian spectrum, a wavelet representation, or another disclosed extraction branch, the penalty-computation system 200 applies the same kernel structure once an ordered characteristic-scale sequence has been obtained.

In preferred continuous embodiments corresponding to FIG. 2, the use of rho_k permits differentiable or almost-everywhere differentiable computation with respect to model parameters, assuming that the selected scale-extraction pathway itself is differentiable or provides differentiable approximations. In some implementations, scale extraction can use local soft-peak estimation, soft-argmax operations, weighted averaging across candidate bins, differentiable span estimators, differentiable spectral estimators, or related mechanisms that preserve compatibility with gradient-based training. In optional quantized embodiments, where m_k is used, discrete treatment can be handled using straight-through estimation, stop-gradient handling, surrogate gradient treatment, or another discrete-compatible optimization strategy.

In some embodiments, the scale sequence 202 can include only a subset of scales selected from a larger pool of candidate scales. In some embodiments, a candidate-scale detector can select the top-K candidates, a confidence-ranked subset, a window-limited subset, or another filtered set of candidate characteristic scales before ordering and penalty computation. In some embodiments, deterministic tie handling can be applied if two candidate scales have equal or near-equal values. In some embodiments, small positive conditioning can be used to avoid undefined ratio or logarithmic operations. Such implementation details can vary without changing the determinative structure shown in FIG. 2.

The penalty-computation system 200 can also be embodied in narrower implementations directed to the explicit ratio-error equation, the explicit ladder-coordinate equation, continuous weighting, quantized-rung weighting, the canonical coupling X_opt=phi/pi, the zero-iff-phi property, or the phi-ladder minimum property. Additional narrower claims can be supported by embodiments in which differentiable estimators are used to construct the scale sequence 202 or in which quantized-rung weighting is used in a hardware-oriented implementation.

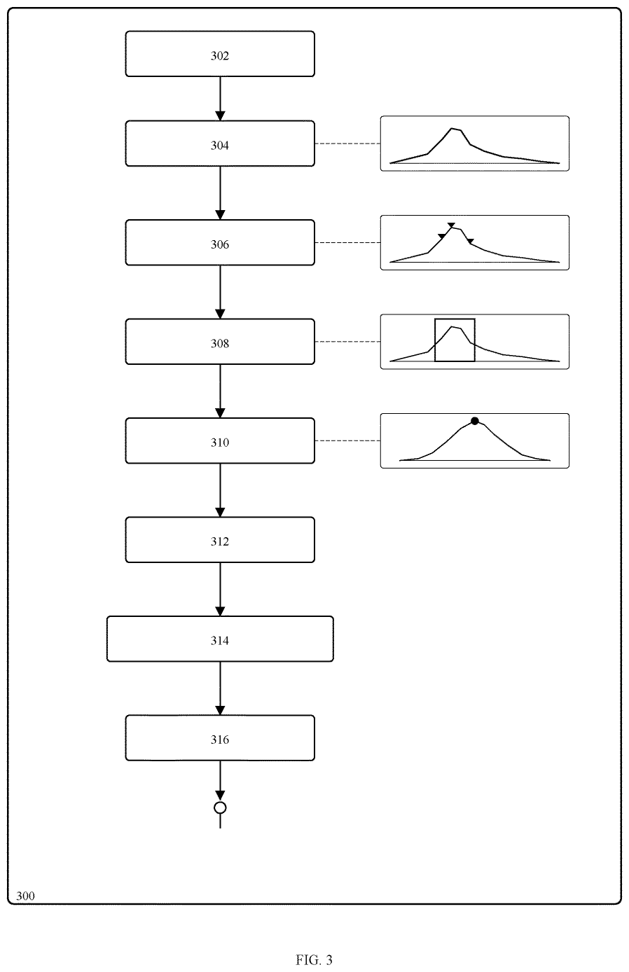

FIG. 2 thus provides the central mathematical kernel around which the remainder of the specification is organized. The extraction of characteristic scales can vary by model type, but once an ordered scale sequence is available, the disclosed ratio-error, ladder-coordinate, weighting, penalty, and canonical coupling structure define the core inventive mechanism. A concrete convolutional-neural-network and FFT-based scale-extraction embodiment is described next with reference to FIG. 3.

FIG. 3 depicts a convolutional-neural-network scale-extraction path 300 that provides a concrete implementation for deriving characteristic scales from convolutional filters, activation traces, or related tensor-derived structures. The CNN scale-extraction path 300 receives as input a convolutional filter or activation trace 302. In some embodiments, the convolutional filter or activation trace 302 is derived directly from learned filter weights. In some embodiments, the convolutional filter or activation trace 302 is derived from intermediate activations generated during a forward pass. In some embodiments, both weight-derived and activation-derived signals are available, and one or more of those signals can be selected for characteristic-scale extraction.

An FFT or power-spectrum generator 304 receives the convolutional filter or activation trace 302 and computes a spectral representation from which one or more characteristic frequencies can be identified. In one embodiment, the FFT or power-spectrum generator 304 computes a real-valued or complex-valued fast Fourier transform and derives a magnitude spectrum or power spectrum therefrom. In some embodiments, the FFT or power-spectrum generator 304 operates on a one-dimensional trace. In some embodiments, multi-dimensional filter data are transformed into a one-dimensional representative spectral signal before candidate-scale identification. In some embodiments, averaging, pooling, dimensional reduction, or channel-wise aggregation can be used to produce an input suitable for spectral analysis.

A candidate-peak selector 306 receives output from the FFT or power-spectrum generator 304 and identifies one or more candidate peaks corresponding to possible characteristic scales. In some embodiments, the candidate-peak selector 306 selects a fixed number of candidate peaks. In some embodiments, the candidate-peak selector 306 selects peaks based on rank, prominence, confidence, or another criterion. In some embodiments, candidate selection can be performed using a top-K procedure. In some embodiments, the selected number of characteristic scales is at least 2 so that adjacent ratio computation is well-defined. The candidate-peak selector 306 therefore defines a provisional set of spectral candidates from which the ordered characteristic-scale sequence can be formed.

A local-window selector 308 defines a local neighborhood around one or more selected candidate peaks. In one embodiment, the local-window selector 308 selects a bounded index window around each candidate peak to permit refined estimation of the characteristic scale. In an exemplary implementation, the local-window selector 308 defines a window having a selected half-width around each candidate peak. Such a window can be symmetric or asymmetric and can be clipped at signal boundaries where appropriate. The local-window selector 308 therefore supplies localized spectral neighborhoods for downstream refinement.

A local soft-peak estimator 310 receives the local neighborhoods and computes refined characteristic-scale values. In preferred embodiments, the local soft-peak estimator 310 performs a differentiable or almost-everywhere differentiable refinement so that the resulting characteristic scales can participate in gradient-based training. In one embodiment, the local soft-peak estimator 310 applies a softmax or related weighting operation across values in a local neighborhood and computes a weighted average location, frequency, or index representing the characteristic scale. In some embodiments, the local soft-peak estimator 310 operates as a soft-argmax estimator. In some embodiments, the local soft-peak estimator 310 can use temperature-controlled weighting. In some embodiments, a local refinement can be omitted and a discrete peak location can be used, although the preferred implementation employs localized refinement for smoother training behavior.

A positivity conditioner 312 receives the refined characteristic-scale values and ensures that the values supplied to the penalty kernel are positive. In some embodiments, the positivity conditioner 312 excludes a direct-current component or zero-frequency component. In some embodiments, the positivity conditioner 312 adds a small positive epsilon to one or more estimated values. In some embodiments, the positivity conditioner 312 clips, offsets, or otherwise conditions values so that division and logarithmic operations in later penalty computation remain well-defined. The positivity conditioner 312 can therefore improve numerical stability and reproducibility without changing the disclosed regularization kernel.

An ordered characteristic-frequency output 314 receives the positive conditioned values and orders them, preferably in ascending form, to produce an ordered sequence of characteristic frequencies. This ordered characteristic-frequency output 314 is then provided through an interface to penalty kernel 316, where the ordered sequence is supplied to the core ratio-error, ladder-coordinate, weighting, and penalty computation described above. In preferred embodiments, ascending ordering is used so that adjacent ratios correspond to progressively increasing scale values. In some embodiments, stable sorting, deterministic tie breaking, source-index priority, confidence-based ordering, or another deterministic policy can be used where candidate values are equal or near-equal.

The embodiment of FIG. 3 therefore provides a concrete make-and-use implementation of the disclosed invention in a convolutional or activation-based setting. A practitioner can implement the disclosed regularizer by tapping a convolutional filter, activation trace, feature map summary, or related tensor-derived structure; generating a spectrum; selecting candidate peaks; refining local peak locations; conditioning the resulting values to remain positive; ordering the values; and supplying the ordered sequence to the disclosed penalty kernel. This embodiment is particularly useful because it provides a direct operational pathway from model tensors to characteristic scales in a form compatible with the core phi-anchored regularization mechanism.

In an exemplary software implementation corresponding to FIG. 3, a selected number of candidate scales can be chosen from a spectral magnitude representation, local offsets can be applied around selected candidates, local magnitude values can be normalized through a temperature-controlled softmax, and refined scale locations can be computed as weighted averages of local positions.

In one reference implementation, an FFT magnitude representation is computed from activations or another selected tensor, candidate peaks are selected using a top-K procedure, local offsets are applied around each candidate peak, local magnitudes are normalized using a temperature-controlled softmax, and a refined characteristic scale is computed as a weighted average of local positions. The resulting characteristic-scale values are then sorted, conditioned to remain positive, and used to compute adjacent ratios, ladder coordinates, ladder-position-dependent weights, and the regularization penalty. In one example implementation, the regularization penalty is added directly to task loss in the training loop, and the resulting combined loss is backpropagated without requiring a change to the model architecture, optimizer, or data loader. Example implementation values can include a selected number of scales, a local window width, and a temperature parameter, but such values remain exemplary rather than mandatory.

Example implementation values can include a selected number of scales, a local window width, and a temperature parameter. Such example values are implementation details and should not be treated as required limitations of the invention. Rather, they demonstrate one practical route for implementing differentiable or near-differentiable scale extraction in a convolutional or activation-based embodiment.

In some embodiments corresponding to FIG. 3, the convolutional filter or activation trace 302 can be derived from a single filter channel. In some embodiments, the input can be aggregated across multiple filters, channels, or mini-batch elements before spectral analysis. In some embodiments, characteristic scales can be extracted from hidden activations instead of static weights so that the penalty acts on representation behavior during training. In some embodiments, both static and dynamic tensor sources can be used and their extracted scales combined into one ordered characteristic-scale sequence or multiple sequences. The disclosed invention therefore does not require that convolutional scale extraction be limited to a single tensor source or one spectral pre-processing configuration.

In preferred embodiments, the embodiment of FIG. 3 remains compatible with backpropagation because the local soft-peak estimator 310 can be implemented in a differentiable or almost-everywhere differentiable manner. This gives the embodiment of FIG. 3 particular significance as a practical pathway for integrating the disclosed regularizer into standard gradient-based training. This embodiment preserves FFT-based scale extraction, spectral candidate selection, local-window refinement, soft-peak estimation, positivity conditioning, ascending ordering, and use of the resulting ordered characteristic-frequency sequence in the disclosed penalty kernel.

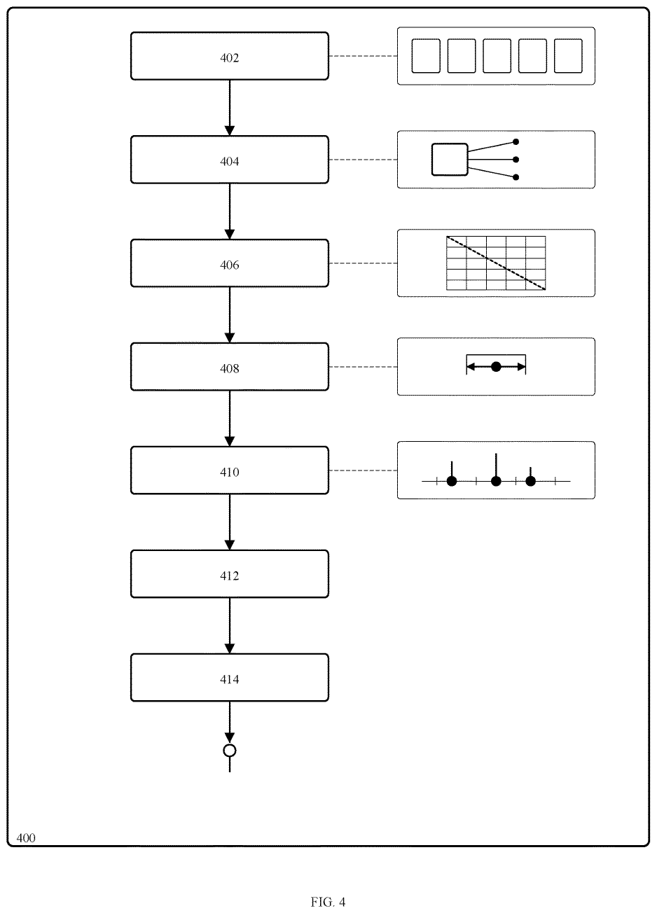

Although FIG. 3 focuses on a convolutional or activation-based extraction path, the disclosed invention is not limited to FFT-derived characteristic frequencies. The core regularization kernel remains the same so long as an ordered sequence of characteristic scales is produced. A transformer embodiment in which characteristic scales are derived from attention behavior is described next with reference to FIG. 4.

FIG. 4 depicts a transformer scale-extraction path 400 in which characteristic scales are derived from attention behavior rather than from a spectral transform. The transformer scale-extraction path 400 receives input tokens 402 and processes the input tokens 402 through one or more attention heads 404 in a transformer architecture. Each attention head 404 produces an attention matrix or attention distribution 406 representing how one token, position, or embedding component attends to one or more other tokens, positions, or embedding components. In the disclosed embodiment, the attention matrix or attention distribution 406 is treated as a source from which one or more operative characteristic scales can be extracted.

An expected-span estimator 408 receives the attention matrix or attention distribution 406 and computes one or more characteristic scales corresponding to attention extent. In some embodiments, the expected-span estimator 408 computes an expected token span, an expected token distance, an attention radius, or another span-based quantity representing the effective reach of an attention head 404. In one embodiment, the expected-span estimator 408 computes a probability-weighted mean token distance or span from the attention distribution 406. In some embodiments, the expected-span estimator 408 computes one or more summary values per head, per layer, per token position, per selected subset of positions, or per selected attention pattern.

The attention-radius outputs 410 generated by the expected-span estimator 408 are supplied to an ordered scale output 412, which produces an ordered sequence of characteristic scales for use by the disclosed regularization kernel. In preferred embodiments, the characteristic scales are ordered in ascending form before being passed through an interface to penalty kernel 414. In some embodiments, the ordered sequence is constructed from outputs of multiple heads. In some embodiments, the ordered sequence is constructed separately for different heads, layers, tokens, or attention groups. In some embodiments, multiple ordered sequences can be regularized independently and their resulting penalties combined.

The embodiment of FIG. 4 therefore provides a concrete make-and-use pathway for applying the disclosed phi-anchored regularizer in transformer architectures. Rather than deriving characteristic scales from a frequency-domain transform, the embodiment of FIG. 4 derives scale from attention reach. Once those characteristic scales are obtained and ordered, the same core kernel described above is applied. Thus, the ordered attention-derived scale sequence is provided to the penalty kernel, which computes phi-referenced ratio errors, ladder coordinates, ladder-position-dependent weights, and the regularization penalty R_phi for incorporation into training.

In some embodiments corresponding to FIG. 4, one attention radius is computed per head. In some embodiments, multiple span metrics are computed from one head, such as local span, global span, or span values restricted to selected token subsets. In some embodiments, attention-derived scales are aggregated across heads within a layer before ordering. In some embodiments, attention-derived scales are aggregated across multiple layers to form a larger scale sequence. In some embodiments, the attention-derived scales can be used in an inter-layer regularization embodiment, while in other embodiments they are used within a single layer or head group.

The attention matrix or attention distribution 406 can be obtained in different ways depending on implementation. In some embodiments, raw attention weights are used directly. In some embodiments, normalized attention weights are used. In some embodiments, masked, windowed, causal, bidirectional, or task-specific attention patterns are used. In some embodiments, the expected-span estimator 408 operates on an attention map after one or more filtering, thresholding, normalization, or smoothing operations. Such choices can affect the precise numerical scale value obtained, but do not alter the identity of the invention so long as the embodiment extracts one or more characteristic scales from attention behavior and supplies an ordered scale sequence to the disclosed penalty kernel.

In preferred transformer embodiments, the expected-span estimator 408 is implemented using a differentiable or almost-everywhere differentiable computation so that the resulting regularization term remains compatible with gradient-based training. For example, probability-weighted span computations can be differentiable with respect to the underlying attention values. This can allow the disclosed regularizer to influence training by shaping how attention heads organize their operative span structure. In benchmark-supported embodiments, attention heads can be observed to organize into phi-like token-span ladders under the disclosed regularization regime. Such benchmark observations can be described as validation material or demonstrated examples, but should not be presented as an inherent limitation of all embodiments.

The embodiment of FIG. 4 preserves transformer-specific extraction implementations in which characteristic scales are derived from attention distributions, expected token spans, attention radii, ordered attention-scale sequences, and incorporation of the resulting sequence into the disclosed phi-anchored penalty kernel. The embodiment also supports downstream use cases such as attention-head analysis and interpretability.

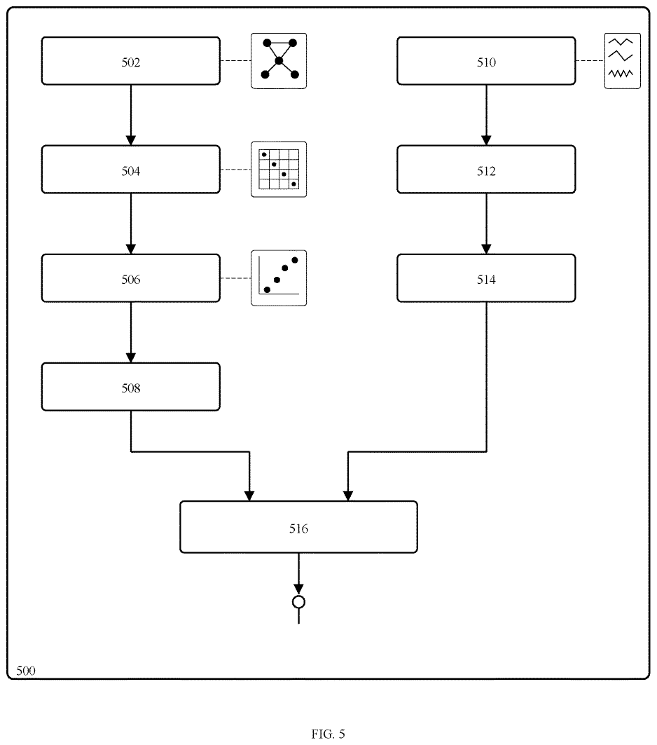

Although FIG. 4 focuses on transformer attention behavior, the disclosed regularization kernel is not limited to attention-derived scales. The same kernel can be applied whenever characteristic scales can be extracted from model structure or behavior and ordered into a scale sequence. Additional non-FFT architecture embodiments, including graph and wavelet embodiments, are described next with reference to FIG. 5.

FIG. 5 depicts an alternative extraction framework 500 that preserves non-convolutional architecture coverage by showing graph-based and wavelet-based scale-extraction embodiments. In each of these embodiments, the architecture-specific extraction path differs from the FFT-based and attention-based paths described above, but the extracted values are still converted into an ordered characteristic-scale sequence and supplied to the same disclosed phi-anchored penalty kernel. Accordingly, FIG. 5 illustrates that the invention is not confined to one particular extraction front end, while still preserving the regularization kernel as the central inventive mechanism.

In a graph embodiment, graph embeddings 502 are provided to a graph Laplacian generator 504. The graph embeddings 502 can be node embeddings, edge-conditioned features, graph-level latent representations, intermediate message-passing states, or another graph-derived tensor structure from which a graph Laplacian or related spectral operator can be formed. The graph Laplacian generator 504 computes a graph Laplacian or another graph-derived operator whose spectral content reflects structural or relational organization in the graph representation.

An eigenvalue extractor 506 receives output from the graph Laplacian generator 504 and extracts one or more non-zero eigenvalues or related graph spectral quantities. In the disclosed embodiment, one or more of those extracted non-zero eigenvalues are treated as characteristic scales. A graph-scale output 508 then produces an ordered sequence of graph-derived characteristic scales for delivery to a shared ordered-scale interface 516. In some embodiments, the graph-scale output 508 orders extracted eigenvalues in ascending form. In some embodiments, one or more selected eigenvalues are filtered, normalized, shifted, conditioned, or subset-selected before ordering. In some embodiments, graph-derived scales can be extracted separately for different graph levels, subgraphs, batches, or message-passing stages.

The graph embodiment of FIG. 5 therefore provides a concrete make-and-use path in which the operative scale sequence is not derived from a spatial-frequency spectrum or an attention distribution, but from graph spectral structure. Once the graph-derived characteristic scales are obtained and ordered, they are supplied to the same core regularization kernel disclosed above, which computes ratio-error values relative to phi, ladder coordinates, ladder-position-dependent weighting, and the resulting regularization penalty. In this way, the graph embodiment extends the applicability of the disclosed regularizer while preserving the identity of the invention as a scale-regularization mechanism.

FIG. 5 also depicts a wavelet embodiment in which wavelet channels 510 are provided to a center-scale extractor 512. The wavelet channels 510 can correspond to multiresolution feature channels, scale-coded decomposition channels, learned wavelet responses, or another wavelet-associated tensor structure. The center-scale extractor 512 determines one or more center scales associated with those channels. In some embodiments, the center scale corresponds to a designed or learned wavelet scale. In some embodiments, the center scale corresponds to an effective center frequency, effective support size, or another channel-associated scale quantity. A wavelet-scale output 514 then produces an ordered sequence of characteristic scales for delivery to the shared ordered-scale interface 516.

In the wavelet embodiment, the characteristic scales are therefore obtained directly from a multiresolution representation rather than inferred from candidate spectral peaks or token-span structure. Once those scales are ordered, they are supplied to the same core penalty kernel used in the previously described embodiments. Thus, the graph embodiment and the wavelet embodiment differ in how characteristic scales are extracted, but they converge into a common downstream regularization path.

The shared ordered-scale interface 516 therefore represents a normalization point at which architecture-specific extraction paths are translated into a common ordered characteristic-scale sequence suitable for use by the disclosed penalty-computation system. In some embodiments, the shared ordered-scale interface 516 applies positivity conditioning, stable ordering, deterministic tie handling, subset selection, scale normalization, or other harmonizing logic before passing the ordered sequence to the penalty kernel. In some embodiments, the shared ordered-scale interface 516 can accept ordered sequences from multiple extraction branches and combine them. In some embodiments, the shared ordered-scale interface 516 can preserve separate sequences and cause separate penalty terms to be computed and combined.

The embodiments of FIG. 5 preserve graph-based and wavelet-based extraction implementations. These embodiments also support downstream use cases such as molecular property prediction, graph-structured feature learning, multiresolution signal processing, and related tasks. Such downstream uses remain subordinate to the core regularization mechanism.

In some graph embodiments, the characteristic scales can be taken from the smallest non-zero eigenvalues, the largest non-zero eigenvalues, a selected subset of eigenvalues, or a ranked subset chosen by contribution, stability, or another criterion. In some wavelet embodiments, the center-scale extractor 512 can operate on fixed wavelet designs, learned wavelet-like channels, or hybrid decomposition layers. In both embodiments, the particular extraction mechanics can vary without changing the core invention so long as one or more characteristic scales are extracted, ordered, and used in the disclosed phi-anchored weighted penalty.

The architecture families shown in FIG. 5 also help support breadth without converting optional embodiments into required limitations. The core invention is not “graph regularization” or “wavelet regularization” as separate inventions. Rather, these are optional architecture embodiments illustrating that the disclosed regularization kernel can operate on characteristic scales derived from different classes of model tensors. This distinction should be preserved throughout drafting and prosecution.

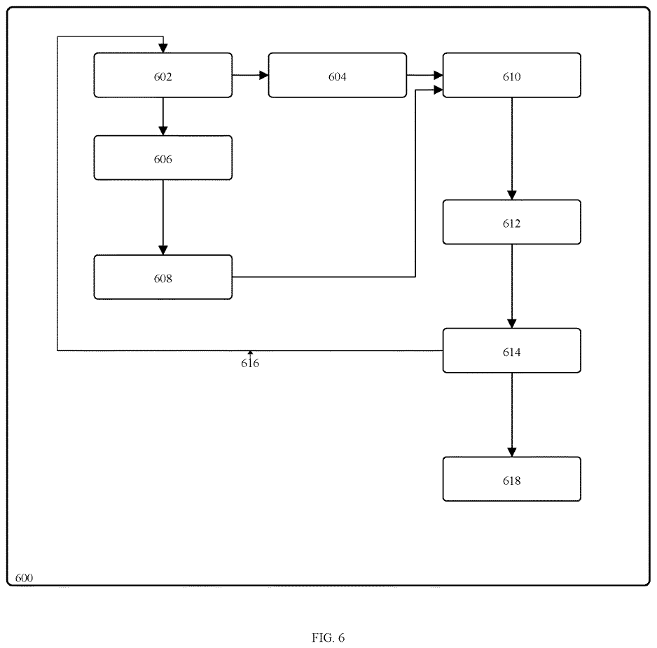

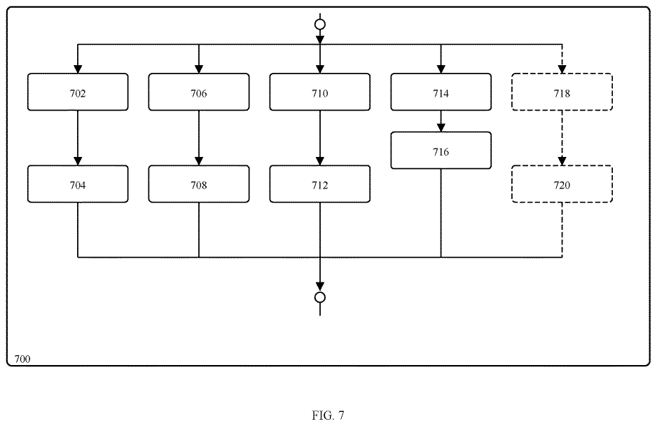

Although FIG. 5 focuses on graph and wavelet embodiments, the disclosed invention also encompasses additional optional architecture embodiments in which characteristic scales are extracted from temporal behavior, from inter-layer relationships, from volumetric data, or from post-pruning model structure. Those optional and alternative embodiment families are described next with reference to FIG. 7, while the operational integration of the regularizer into a training loop is first described with reference to FIG. 6.

FIG. 6 depicts a training loop 600 showing how the disclosed regularizer is integrated into model training. A forward-pass module 602 receives input data and computes model outputs using the current model parameters. A task-loss computation 604 then computes a task loss associated with the training objective, such as a classification loss, regression loss, sequence-modeling loss, contrastive loss, reconstruction loss, or another task-specific training objective. The training loop 600 also includes a tensor tap point 606 at which one or more model tensors are selected for characteristic-scale extraction during the forward pass or at another suitable point in the training cycle.

A regularization call 608 receives the selected tensor information from the tensor tap point 606 and invokes the disclosed characteristic-scale extraction and phi-anchored penalty computation. In some embodiments, the regularization call 608 invokes an FFT-based extraction path such as the embodiment of FIG. 3. In some embodiments, the regularization call 608 invokes an attention-radius extraction path such as the embodiment of FIG. 4. In some embodiments, the regularization call 608 invokes a graph-based or wavelet-based extraction path such as one of the embodiments of FIG. 5. In some embodiments, different extraction paths can be selected based on model type, tensor type, layer identity, or user configuration. In all such cases, the regularization call 608 ultimately produces a regularization penalty R_phi computed from an ordered characteristic-scale sequence.

A combined-loss output 610 receives the task loss from the task-loss computation 604 and the regularization penalty from the regularization call 608. In the canonical embodiment, the combined-loss output 610 is computed as:

L=L_task+R_phi,

where:

R_phi=X_opt*(1/(K−1))*sum_k (w_k*e_k\hat{ }2),

and:

X_opt=phi/pi.

In the canonical embodiment, no tunable scalar coefficient multiplying R_phi is required. Thus, the training loop 600 differs from conventional regularization loops that require a user-selected regularization multiplier distinct from the disclosed kernel.

A backward-propagation module 612 receives the combined loss and computes gradients for updating model parameters. In preferred embodiments, the continuous branch of the disclosed regularizer is differentiable or differentiable almost everywhere and is therefore compatible with standard backpropagation. In optional quantized embodiments, discrete ladder treatment can be handled by straight-through estimation, stop-gradient logic, surrogate-gradient logic, or another training-compatible discrete-treatment mechanism. The backward-propagation module 612 then supplies gradients to a parameter-update module 614.

The parameter-update module 614 updates model parameters using the combined loss and the computed gradients. The parameter-update module 614 can use any suitable optimizer, including, for example, stochastic gradient descent, adaptive gradient methods, momentum-based methods, or other optimization techniques. The repeated training-loop path 616 indicates that the disclosed process can be repeated across mini-batches, batches, epochs, selected update intervals, or another training schedule. The result is a trained-model state 618 in which learned representations have been influenced by the disclosed phi-anchored regularization mechanism.

FIG. 6 therefore illustrates that the disclosed regularizer can be inserted into a conventional training loop without requiring redesign of the underlying model architecture. In a reference integration embodiment, the disclosed regularizer is added to the training loop as a direct additive term in the loss computation, such that the regularizer can be introduced with minimal code-path modification while preserving the existing model architecture, optimizer configuration, and data-loader flow. In a preferred implementation, the regularizer is added as an additional computational call that taps one or more tensors, computes an ordered characteristic-scale sequence, evaluates the disclosed phi-anchored penalty, and adds that penalty to the task loss. This architecture supports practical software integration because the model architecture, optimizer, and data loader can remain unchanged while the regularizer is introduced as an additive training component.

In some embodiments corresponding to FIG. 6, the tensor tap point 606 is positioned at one selected layer. In some embodiments, the tensor tap point 606 is positioned at multiple layers. In some embodiments, separate regularization calls 608 are evaluated for different tensor sources and their penalty values are combined. In some embodiments, a single ordered characteristic-scale sequence is assembled from multiple tensor sources before penalty computation. In some embodiments, different penalty terms can be computed for different branches or stages of the model and then added together or otherwise combined. Such variants do not alter the disclosed core mechanism so long as the regularizer remains based on extracted characteristic scales, phi-ratio deviation, ladder-position-dependent weighting, and training-time incorporation of the resulting penalty.

In some embodiments, the regularization call 608 is evaluated at every training step. In some embodiments, the regularization call 608 is evaluated periodically, conditionally, or according to a schedule. In some embodiments, the regularization call 608 is applied throughout training. In some embodiments, the regularization call 608 is applied only during an initial training phase, a later refinement phase, a fine-tuning phase, or another selected interval. In some embodiments, the regularization strength remains fixed by the canonical coupling throughout training. In other embodiments, while the disclosed kernel remains the same, one or more auxiliary scheduling or activation conditions can be used to control when the regularization call is active. Such scheduling choices should be disclosed as optional implementation details rather than as required elements of the core invention.

The training loop 600 also supports additive compatibility with other regularization procedures. In some embodiments, the disclosed regularizer is used alone. In some embodiments, it is used together with weight decay, dropout, spectral normalization, norm constraints, data augmentation losses, consistency losses, or another regularization or stabilization term. In such cases, the disclosed phi-anchored penalty remains a distinct term computed from characteristic-scale structure rather than from raw weight magnitude alone. This additive compatibility preserves implementation flexibility while maintaining the disclosed phi-anchored penalty as a distinct term computed from characteristic-scale structure.

In some implementations, the combined-loss output 610 can also feed one or more logging, reporting, or validation mechanisms. For example, ratio-error values, ladder-coordinate values, penalty values, performance metrics, scale visualizations, and overhead measurements can be recorded during training. In some embodiments, these quantities can be used to compare baseline training and regularizer-enabled training, to validate that learned scales move toward a phi-ladder, to support pruning or architecture selection, or to generate a machine-produced output associated with the training process. Such reporting paths remain subordinate to the core invention but support product, output, and validation-related claim positions.

The training-loop structure of FIG. 6 can be implemented using software components, framework-integrated functions, or hardware-assisted execution paths.

Having described how the disclosed regularizer is integrated into training, optional and alternative embodiment families are described next with reference to FIG. 7.

FIG. 7 depicts an optional-embodiment framework 700 showing additional embodiment families that remain subordinate to the core regularization mechanism. The framework 700 includes an inter-layer branch 702, an inter-layer scale extractor 704, a temporal branch 706, a time-scale extractor 708, a volumetric branch 710, a 3D scale extractor 712, a pruning-aware branch 714, a post-pruning verification module 716, a Fibonacci-variant branch 718, and an alternative penalty module 720. These branches illustrate ways in which the disclosed phi-anchored regularizer can be adapted, extended, or alternatively instantiated without changing the identity of the core invention.

The inter-layer branch 702 represents embodiments in which characteristic scales are not limited to scales extracted within a single tensor source or a single model layer. Instead, scales can be extracted from multiple layers, and the inter-layer scale extractor 704 can form an ordered sequence representing effective receptive fields, effective spans, effective graph scales, effective multiresolution scales, or another cross-layer scale organization. In some embodiments, the disclosed penalty is applied to that inter-layer sequence so as to encourage a phi-ladder across layers rather than only within one layer. In some embodiments, the disclosed penalty is applied both within layers and across layers. In some embodiments, separate intra-layer and inter-layer penalty terms are computed and then combined. The inter-layer branch 702 is optional and should not be treated as a required limitation of the core invention.

The temporal branch 706 represents embodiments in which characteristic scales are extracted from temporal behavior. In such embodiments, the time-scale extractor 708 can derive characteristic time scales from recurrent hidden states, temporal activations, temporal filters, state-transition responses, sequence-memory reach, or another time-dependent tensor-derived structure. In some embodiments, the extracted characteristic time scales are ordered and supplied to the disclosed penalty kernel in the same manner as spatial, spectral, attention-derived, graph-derived, or wavelet-derived scales. In this way, the disclosed regularizer can be applied in recurrent, temporal, or time-series models while preserving the same core phi-ratio and ladder-weighting structure.

The volumetric branch 710 represents embodiments directed to volumetric or three-dimensional data processing, and the 3D scale extractor 712 derives characteristic volumetric scales from one or more tensors associated with a three-dimensional model. In some embodiments, the 3D scale extractor 712 computes volumetric spatial frequencies, effective volumetric receptive fields, scale parameters from three-dimensional convolutional filters, or another volumetric scale descriptor. Those characteristic scales can then be ordered and supplied to the disclosed regularization kernel. The volumetric branch 710 therefore provides optional support for three-dimensional imaging, medical-imaging, point-cloud, or other volumetric processing applications without changing the core structure of the regularizer.

The pruning-aware branch 714 represents embodiments in which the disclosed regularizer is used in connection with pruning or post-pruning analysis. In some embodiments, a model is first trained using the disclosed phi-anchored regularizer and then pruned. In some embodiments, pruning is performed first and a post-pruning verification module 716 evaluates whether one or more remaining extracted characteristic scales continue to conform to the disclosed phi-ladder organization. In some embodiments, the post-pruning verification module 716 computes ratio-error values, penalty values, or related diagnostics for a pruned model. In some embodiments, those values can be used as a quality-assurance measure for pruning. In some embodiments, post-pruning verification can be used together with additional fine-tuning. The pruning-aware branch 714 is therefore an optional implementation family that remains subordinate to the training-time regularization kernel.

The Fibonacci-variant branch 718 represents an alternative embodiment in which an alternative penalty module 720 uses a Fibonacci-sequence-related target rather than direct ratio error to phi. In one such embodiment, the penalty can be based on deviation from a Fibonacci integer sequence or Fibonacci-derived scaling pattern, particularly where large-k behavior approaches the phi-ladder because F_(n+1)/F_n tends toward phi. This branch is disclosed as an alternative embodiment and should not redefine the invention away from the phi-ratio kernel. The core invention remains the phi-anchored weighted penalty defined above. The Fibonacci-variant branch 718 is included to preserve a disclosed alternative, but it should remain clearly subordinate to the canonical phi-based regularizer.

FIG. 7 therefore collects optional and alternative embodiment families into a single architecture map. This figure is useful for demonstrating that the disclosed invention can be extended or instantiated across different model organizations, data modalities, and training workflows while preserving the same underlying regularization logic. At the same time, the figure also reinforces that these branches are not the core invention itself. The invention is not an omnibus platform made of every downstream use or future extension. Rather, these optional and alternative branches are additional support layers built around the central phi-anchored regularization mechanism.

In some embodiments corresponding to FIG. 7, more than one optional branch can be used together. For example, a model can use inter-layer regularization and pruning-aware verification. In some embodiments, a temporal embodiment can also operate in a volumetric architecture. In some embodiments, one or more optional branches can be activated conditionally according to model type, training phase, or user configuration. In some embodiments, different branches can generate separate penalty terms that are combined. In some embodiments, one branch can be used for training and another branch can be used for analysis or validation. Such combinations remain within the scope of the disclosure so long as the central regularization mechanism remains tied to extracted characteristic scales, phi-ladder structure, and penalty incorporation during training or evaluation.

The embodiment families shown in FIG. 7 preserve additional implementation families for inter-layer, temporal, volumetric, pruning-aware, and Fibonacci-based embodiments.

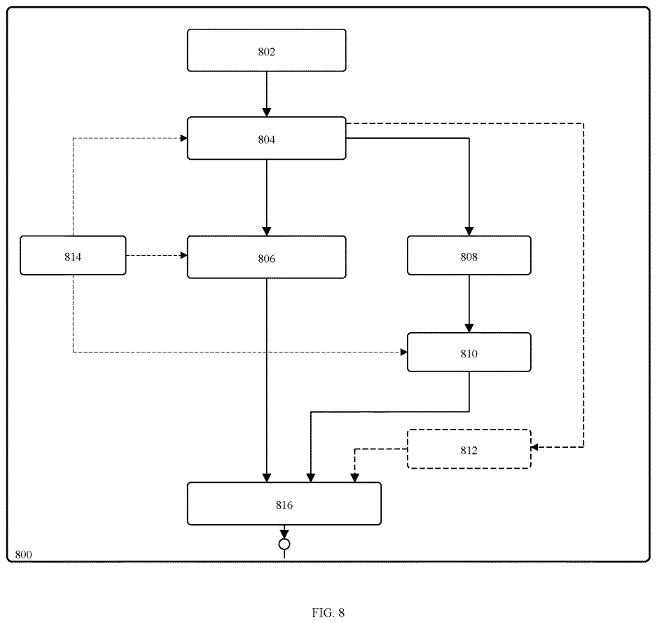

After the optional and alternative embodiment families of FIG. 7, the specification next describes software and hardware implementation embodiments with reference to FIG. 8.

FIG. 8 depicts an implementation architecture 800 showing software and optional hardware embodiments for executing the disclosed regularizer. The implementation architecture 800 includes a training-framework interface 802, a regularization library 804, a CPU or GPU execution path 806, an FPGA FFT core 808, a hardware penalty engine 810, an optional NPU instruction interface 812, a memory or buffer path 814, and a return path to training loop 816. FIG. 8 is intended to show that the disclosed regularizer can be implemented as software, firmware, hardware-assisted software, or a more specialized execution path while preserving the same underlying regularization kernel.

The training-framework interface 802 represents software integration points through which the disclosed regularizer can be incorporated into an existing machine-learning workflow. In some embodiments, the training-framework interface 802 is implemented as a callback, a regularizer component, a training hook, a loss-wrapper component, a plug-in module, an optimizer-adjacent function, or another framework-compatible integration layer. In some embodiments, the training-framework interface 802 is configured for use with a deep-learning framework that supports tensor extraction, forward-pass access, gradient propagation, and modular loss computation. The training-framework interface 802 therefore provides a practical path by which the disclosed regularizer can be inserted into training without requiring redesign of the underlying model architecture.

The regularization library 804 represents a software embodiment in which instructions for the disclosed characteristic-scale extraction and penalty computation are packaged as a reusable software component. In some embodiments, the regularization library 804 includes code for selecting tensors, extracting characteristic scales, conditioning and ordering scale values, computing phi-ratio deviations, computing ladder coordinates, computing ladder-position-dependent weights, aggregating a regularization penalty, and combining the penalty with task loss. In some embodiments, the regularization library 804 includes one or more architecture-specific extraction paths such as an FFT-based extraction path, an attention-radius extraction path, a graph spectral extraction path, or a wavelet-based extraction path. In some embodiments, the regularization library 804 is distributed as a package, installable component, or code library. Package name, code size, and distribution format can vary and should be treated as implementation examples rather than central claim limitations.

The CPU or GPU execution path 806 represents a general-purpose execution path in which the disclosed regularizer is computed by one or more processors, including one or more graphics-processing units where appropriate. In many embodiments, the CPU or GPU execution path 806 is sufficient for training and validation. In some embodiments, FFT operations, matrix operations, attention computations, spectral operations, weighting operations, and loss aggregation are performed using general-purpose tensor-processing resources. In some embodiments, the CPU or GPU execution path 806 is used in a pure software embodiment. In some embodiments, the CPU or GPU execution path 806 is used together with a more specialized hardware path for one or more selected computational stages.

The FPGA FFT core 808 represents an optional hardware-assisted embodiment in which at least part of the scale-extraction path is accelerated through field-programmable hardware. In some embodiments, the FPGA FFT core 808 computes an FFT or a related spectral transform used in a convolutional or activation-based embodiment such as that shown in FIG. 3. In some embodiments, the FPGA FFT core 808 computes a reduced, partial, windowed, streaming, or batch spectral transform. In some embodiments, the FPGA FFT core 808 operates together with the hardware penalty engine 810 so that extracted characteristic scales or intermediate spectral data can be passed directly to downstream penalty computation logic. The FPGA FFT core 808 is optional and should not be treated as a required element of the core invention.

The hardware penalty engine 810 represents an optional hardware-assisted embodiment in which one or more portions of the disclosed penalty kernel are implemented in dedicated logic, programmable logic, reconfigurable logic, or another hardware-assisted structure. In some embodiments, the hardware penalty engine 810 computes ratio-error values, ladder coordinates, weighting values, penalty aggregation, or combinations thereof. In some embodiments, the hardware penalty engine 810 operates on continuous ladder coordinates. In some embodiments, the hardware penalty engine 810 operates on quantized rung indices, which can make the quantized-rung branch particularly useful as a hardware-oriented fallback embodiment. In some embodiments, the hardware penalty engine 810 can therefore provide a path toward lower-latency, lower-overhead, or more integrated execution of the disclosed regularizer.

The optional NPU instruction interface 812 represents a more specialized execution embodiment in which one or more parts of the disclosed regularizer are exposed through a neural-processing instruction, command, primitive, or execution interface. In some embodiments, the optional NPU instruction interface 812 can invoke a regularization routine associated with the disclosed phi-anchored kernel. In some embodiments, the optional NPU instruction interface 812 can operate on extracted scales, tensor windows, head summaries, or another reduced representation. The optional NPU instruction interface 812 is an optional implementation pathway and should be understood as a non-required hardware-oriented embodiment. Where a particular instruction-level implementation is not fully instantiated, the NPU-oriented discussion should be understood as interface-level or architecture-level support for specialized execution of the disclosed regularizer rather than as a required limitation of the invention. It remains useful to disclose this interface as an additional hardware-oriented implementation path.

The memory or buffer path 814 represents storage, transfer, and staging resources used to hold selected tensors, spectral values, candidate scales, refined scale outputs, ladder-coordinate values, penalty terms, or associated metadata during execution. In some embodiments, the memory or buffer path 814 is implemented in system memory. In some embodiments, it is implemented in on-device memory, accelerator-local memory, FPGA memory resources, cache, or shared buffers. In some embodiments, the memory or buffer path 814 supports batch processing, streaming execution, or staged execution between extraction and penalty computation. In some embodiments, deterministic tie handling, stable ordering, positivity conditioning, and logging can also operate through the memory or buffer path 814.

The return path to training loop 816 returns the disclosed penalty output, combined loss output, validation output, or related control information back into a training workflow such as the training loop described with reference to FIG. 6. In some embodiments, the return path to training loop 816 returns only R_phi. In some embodiments, it returns a combined loss value. In some embodiments, it returns a report, metric, or diagnostic in addition to the penalty. In some embodiments, the return path to training loop 816 allows the disclosed regularizer to operate as a drop-in training component regardless of whether its internal execution occurred entirely in software, partly in software and partly in hardware, or through a specialized execution interface.

FIG. 8 therefore shows that the disclosed invention is not limited to one deployment style. The same regularization kernel can be embodied as software instructions stored on a non-transitory computer-readable medium, as a framework-integrated library or module, as a processor-executed routine, as an accelerator-assisted path, or as a more specialized hardware implementation.

In some embodiments corresponding to FIG. 8, the implementation architecture 800 is purely software-based and no dedicated hardware assistance is used. In some embodiments, FFT or extraction stages are hardware-assisted while penalty computation remains software-based. In some embodiments, one or more portions of the penalty kernel are hardware-assisted while extraction remains software-based. In some embodiments, the same regularization library 804 can dispatch execution across the CPU or GPU execution path 806, the FPGA FFT core 808, the hardware penalty engine 810, or the optional NPU instruction interface 812 depending on deployment environment, device availability, latency targets, power constraints, or another runtime condition. Such dispatch logic does not alter the core invention and should be treated as an implementation choice.

In some embodiments, the implementation architecture 800 also supports machine-generated outputs beyond the penalty itself. For example, the regularization library 804 or the return path to training loop 816 can generate ratio-error reports, ladder visualizations, validation logs, overhead measurements, or another output product associated with the disclosed training process. Such outputs can support software-product claims, output-report claims, or trained-model-by-process claims when drafted carefully, but should remain secondary to the main method and system concepts.

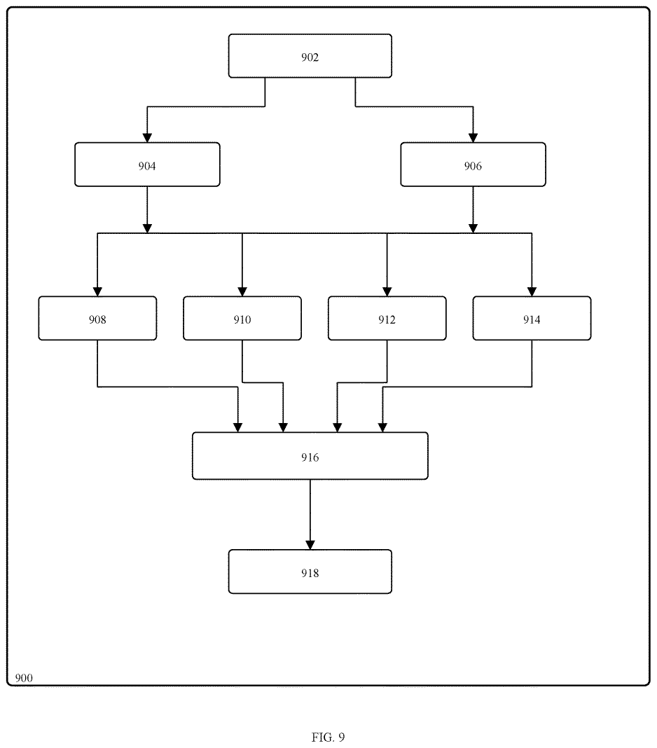

The software and hardware implementation embodiments of FIG. 8 are followed by a benchmark and validation workflow, described next with reference to FIG. 9.

FIG. 9 depicts a validation workflow 900 for evaluating the disclosed regularizer against one or more baseline training configurations. The validation workflow 900 includes a dataset or benchmark selector 902, a baseline regularizer path 904, a GRR-enabled run path 906, a ratio-error measurement module 908, a task-performance measurement module 910, a scale-visualization module 912, an overhead measurement module 914, an acceptance-criteria block 916, and a validation report 918. FIG. 9 is intended to preserve enablement and prosecution support by showing that the disclosed invention is not merely conceptual, but can be implemented, measured, compared, and validated using concrete workflows and outputs.

The dataset or benchmark selector 902 identifies one or more datasets, benchmark tasks, validation corpora, or evaluation configurations to which the disclosed regularizer will be applied. In some embodiments, the dataset or benchmark selector 902 selects an image-classification benchmark. In some embodiments, the dataset or benchmark selector 902 selects a language-model benchmark. In some embodiments, the dataset or benchmark selector 902 selects a genomic or sequence-based benchmark. In some embodiments, the dataset or benchmark selector 902 selects a graph, molecular, detector-event, edge-AI, or other downstream evaluation setting. The dataset or benchmark selector 902 therefore provides a structured basis for comparing baseline training against training in which the disclosed phi-anchored regularizer is enabled.

The baseline regularizer path 904 represents one or more comparison conditions in which the machine-learning model is trained using no regularizer or using another regularizer such as L2, dropout, spectral normalization, or another baseline technique. The GRR-enabled run path 906 represents a training condition in which the disclosed regularizer is active. In the GRR-enabled run path 906, characteristic scales are extracted from one or more model tensors, adjacent scale ratios are compared to phi, deviations are weighted by ladder position, and the resulting penalty R_phi is incorporated into training. The validation workflow 900 therefore enables side-by-side comparison between one or more baseline conditions and the disclosed regularization condition.

A ratio-error measurement module 908 evaluates one or more scale-organization metrics associated with the baseline regularizer path 904 and the GRR-enabled run path 906. In some embodiments, the ratio-error measurement module 908 computes a mean, normalized, median, or otherwise aggregated ratio-error quantity derived from adjacent extracted scale ratios. In some embodiments, the ratio-error measurement module 908 computes values directly corresponding to the disclosed ratio-error term e_k=f_(k+1)/f_k−phi. In some embodiments, the ratio-error measurement module 908 computes summary statistics across layers, heads, channels, batches, or full benchmark runs. The ratio-error measurement module 908 therefore provides a concrete way to assess whether learned scale organization moves toward the disclosed phi-ladder.

A task-performance measurement module 910 evaluates one or more task metrics associated with the trained model. In some embodiments, the task-performance measurement module 910 measures classification accuracy, perplexity, loss, precision, recall, ranking quality, regression quality, sequence-discovery quality, or another task-relevant metric. In some embodiments, the task-performance measurement module 910 measures benchmark performance for a model trained along the baseline regularizer path 904 and compares that performance with benchmark performance for a model trained along the GRR-enabled run path 906. This permits the disclosed regularizer to be assessed not only for scale organization, but also for model-performance consequences.

A scale-visualization module 912 generates one or more machine-produced visual or structured outputs representing learned scale organization. In some embodiments, the scale-visualization module 912 produces plots, tables, ordered scale lists, rung-coordinate outputs, attention-span distributions, receptive-field visualizations, or another representation of the extracted characteristic scales. In some embodiments, the scale-visualization module 912 is used to confirm whether learned scales approximate ratios such as 1:phi:phi\hat{ }2 or corresponding discrete approximations. In some embodiments, the scale-visualization module 912 supports interpretability, debugging, architecture comparison, pruning analysis, or downstream analysis. Such outputs remain subordinate to the core invention, but they are valuable as validation and output products of the disclosed training process.

An overhead measurement module 914 measures computational, timing, throughput, memory, latency, or related execution costs associated with the disclosed regularizer. In some embodiments, the overhead measurement module 914 measures wall-clock overhead, per-batch overhead, device-time overhead, memory overhead, or another implementation-cost metric. In some embodiments, the overhead measurement module 914 compares baseline training cost with regularizer-enabled training cost. In some embodiments, overhead measurements are made for software execution only. In some embodiments, overhead measurements are made for software-assisted or hardware-assisted embodiments. The overhead measurement module 914 therefore provides support for implementation practicality and can be used to generate benchmark-configured evidence or target-based validation statements.

The acceptance-criteria block 916 represents one or more benchmark criteria, validation targets, or acceptance thresholds used in evaluating the disclosed regularizer. In some embodiments, the acceptance-criteria block 916 includes a ratio-error threshold. In some embodiments, the acceptance-criteria block 916 includes a target for attention-radius convergence toward a phi-ladder. In some embodiments, the acceptance-criteria block 916 includes a target associated with codon-periodicity discovery or another downstream sequence feature. In some embodiments, the acceptance-criteria block 916 includes a target associated with self-similar receptive-field organization. In some embodiments, the acceptance-criteria block 916 includes a computational-overhead target. These acceptance criteria should be presented in the specification as validation-pathway material, benchmark-configured targets, or acceptance criteria for selected implementations rather than as universal guarantees, inherent outcomes, or limitations required in every embodiment of the invention.

The validation report 918 aggregates outputs of the ratio-error measurement module 908, the task-performance measurement module 910, the scale-visualization module 912, the overhead measurement module 914, and the acceptance-criteria block 916. In some embodiments, the validation report 918 includes baseline-versus-GRR comparison results. In some embodiments, the validation report 918 includes extracted characteristic scales, ratio-error summaries, performance summaries, overhead summaries, and visual outputs. In some embodiments, the validation report 918 is a machine-generated output product of the disclosed process and may be stored, displayed, transmitted, or associated with a trained model, experiment record, or deployment artifact.

FIG. 9 therefore provides a concrete validation and benchmark framework supporting the disclosed regularizer. The workflow is useful because it separates reported benchmark material from future validation targets. For example, certain embodiments described in the source materials are already associated with benchmark-reported image-classification, language-model, and genomic behavior, whereas other numerical or acceptance-oriented statements are better treated as validation targets or benchmark-configured goals. Maintaining this distinction improves drafting discipline and reduces support-level confusion.

In some embodiments corresponding to FIG. 9, the validation workflow 900 is used during development of the disclosed regularizer, during model comparison, after training to verify that a trained model exhibits reduced ratio error or increased phi-ladder conformity, or for pruning qualification, architecture comparison, or downstream application validation. In some embodiments, the validation workflow 900 is used to generate benchmark-configured outputs associated with ratio-error thresholds, overhead bounds, or application-specific validation outcomes.

The validation workflow 900 also supports careful separation of demonstrated material, mixed-status material, and prophetic material. For example, benchmark-supported image-classification, language-model, and DNA sequence results can be described as demonstrated or benchmark-supported material. Optional hardware metrics, instruction-level embodiments, or more aggressive application-generalization claims can be separated into mixed-status or prophetic categories. This support-level separation should be maintained throughout the specification so that the core invention remains both broad and defensible.

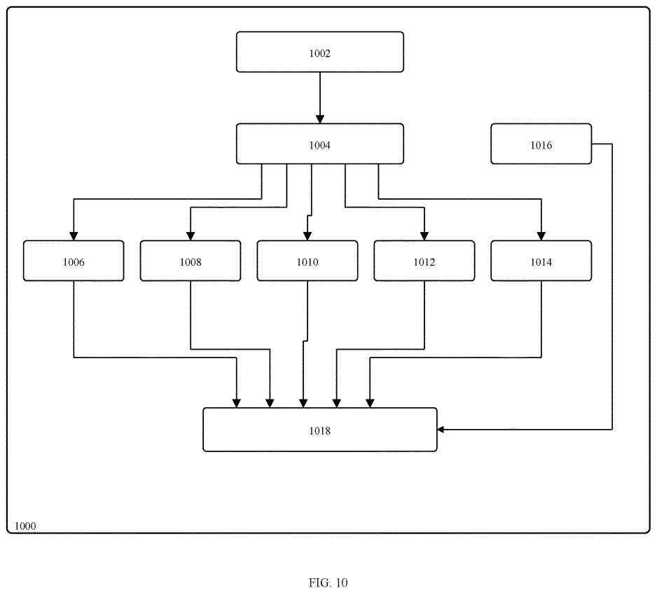

The validation and benchmark architecture of FIG. 9 is complemented by a formal-verification and evidence architecture, which is described next with reference to FIG. 10.

FIG. 10 depicts an evidence architecture 1000 showing how mathematical definitions, machine-checked support, benchmark evidence, and disclosure-support structures relate to one another in the present disclosure. The evidence architecture 1000 includes a mathematical definitions block 1002, a Lean implementation file 1004, a weight-positivity proof block 1006, a weight-decay proof block 1008, a non-negativity proof block 1010, a zero-iff-phi proof block 1012, a coupling-from-phi proof block 1014, a benchmark-evidence block 1016, and an interface 1018. FIG. 10 is provided to clarify that the present disclosure includes both formal and empirical support for the disclosed regularizer, while also making clear that machine-checked support is used as evidence for the mathematical properties of the disclosed kernel rather than as a required runtime element of the disclosed methods or systems.

The mathematical definitions block 1002 represents the definitional core of the disclosed regularizer. In some embodiments, the mathematical definitions block 1002 includes the ordered scale sequence f_k, the ratio-error term e_k=f_(k+1)/f_k−phi, the ladder-coordinate term rho_k =log_phi(f_k/f_0), the optional quantized rung m_k=floor(rho_k), the continuous weighting term w_k=phi\hat{ }(−rho_k), the optional quantized weighting term w_k=phi\hat{ }(−m_k), the regularization penalty R_phi=X_opt*(1/(K−1))*sum_k (w_k*e_k\hat{ }2), and the canonical coupling X_opt=phi/pi. The mathematical definitions block 1002 therefore provides the core mathematical structure whose properties are supported by the additional evidence shown in FIG. 10.

The Lean implementation file 1004 represents one or more machine-readable formalization files in which mathematical properties of the disclosed regularizer are encoded and checked. In the disclosed source materials, a Lean formalization is used to support specific properties of the regularization kernel. The Lean implementation file 1004 is not itself required for practicing the invention. Rather, it serves as a formal-support artifact showing that the disclosed kernel has been expressed in a machine-checkable framework and that specified mathematical properties have been verified within that framework. The presence of the Lean implementation file 1004 therefore strengthens definitional clarity, internal consistency, and prosecution-facing technical credibility without transforming formal verification into an operational step of the claimed training method.

The weight-positivity proof block 1006 represents formal support for the proposition that the disclosed weighting structure is positive under the disclosed conditions. In the disclosed source materials, one such property is identified as weight_positive. This support is relevant because the disclosed penalty aggregates weighted squared ratio-error terms and the positivity of the weighting contributes to the structure of the regularizer and its non-negative character. The weight-decay proof block 1008 represents formal support for the proposition that weighting decays with ladder position under the disclosed ladder-based weighting structure. In the disclosed source materials, one such property is identified as weight_decays. This support is relevant because it confirms that the disclosed ladder-position-dependent weighting behaves in accordance with the intended phi-ladder organization rather than as an arbitrary weighting assignment.

The non-negativity proof block 1010 represents formal support for the proposition that the disclosed penalty terms are non-negative. In the disclosed source materials, one such property is identified as term_nonneg. This support is relevant because the regularizer is expressly disclosed as non-negative and because the penalty is built from weighted squared ratio-error terms. The zero-iff-phi proof block 1012 represents formal support for the proposition that the ratio-error term vanishes if and only if the corresponding consecutive scale ratio equals phi. In the disclosed source materials, one such property is identified as term_zero_iff_phi. This support is particularly important because it underlies the disclosed statements that R_phi=0 iff all consecutive extracted scale ratios equal phi and that the global minimum of the regularizer is the phi-ladder.

The coupling-from-phi proof block 1014 represents formal support for the disclosed canonical coupling. In some embodiments, the formal-support material also includes a parameter-free canonical statement showing that X_opt=phi/pi and that phi satisfies phi\hat{ }2=phi+1 within the disclosed self-similar framework. This support reinforces that the canonical coupling is not introduced as an independently tuned parameter, but is fixed within the disclosed kernel. In the disclosed source materials, one such property is identified as coupling_from_phi, and related support is also associated with a parameter-free canonical statement. This block therefore supports the disclosed posture that X_opt=phi/pi in the canonical embodiment and that no tunable scalar coefficient multiplying R_phi is required in that canonical embodiment. The coupling-from-phi proof block 1014 should be used in the specification to reinforce the determinative nature of the disclosed coupling, while avoiding unsupported legal conclusions about what prior art may or may not teach.

The benchmark-evidence block 1016 represents empirical and benchmark-oriented support for the disclosed regularizer. In some embodiments, the benchmark-evidence block 1016 includes reported benchmark material associated with image classification, language-model behavior, or genomic feature discovery. In some embodiments, the benchmark-evidence block 1016 includes benchmark-configured measurements of ratio error, task performance, scale organization, overhead, or another implementation-relevant quantity. In some embodiments, the benchmark-evidence block 1016 also includes validation targets or acceptance criteria. The benchmark-evidence block 1016 is therefore distinct from the machine-checked support shown in blocks 1006 through 1014. The former addresses observed or benchmark-configured behavior of implemented embodiments, whereas the latter addresses formal properties of the disclosed mathematical kernel.

More specifically, the machine-checked support addresses mathematical and definitional properties of the disclosed kernel, whereas the benchmark-evidence block 1016 addresses observed, measured, or benchmark-configured behavior of implemented embodiments, including task performance, ratio-error reduction, scale organization, and implementation overhead.

The interface 1018 represents a disclosure-support structure through which definitional statements, implementation details, benchmark material, and formal-support material are organized together. In some embodiments, the interface 1018 correlates the disclosed kernel, the formal-support material, and the benchmark-oriented evidence so that the regularizer is presented as a technically specific and internally coherent machine-learning training mechanism.

FIG. 10 therefore clarifies the support structure of the present disclosure. The invention is not a claim to formal verification itself. Nor is the invention limited to embodiments in which a proof engine is executed during training. Rather, the formal-support architecture of FIG. 10 is included because the source materials provide unusually explicit support for the mathematical behavior of the disclosed regularization kernel, and that support is useful in a non-provisional specification to preserve determinative language, explicit constants, exact kernel structure, and fallback positions. Likewise, the benchmark-evidence block 1016 is included because the source materials also provide implementation-oriented and benchmark-oriented support for use of the disclosed kernel in concrete machine-learning contexts.

In some embodiments corresponding to FIG. 10, the formal-support material is used to reinforce definitional clarity in the Detailed Description and explicit mathematical relationships disclosed for the regularization kernel. In some embodiments, it is used to preserve the disclosed posture that phi is not an arbitrary selected constant and that X_opt=phi/pi in the canonical embodiment. In some embodiments, the benchmark-evidence material is used to support examples and validation sections. Maintaining this distinction between formal support and empirical support can reduce support-level confusion and can help keep prophetic, demonstrated, and mixed-status material properly separated in the final application.

The evidence architecture shown in FIG. 10 also reinforces that the present disclosure is broad but disciplined. The core invention remains the extraction of characteristic scales from model tensors, the comparison of adjacent scale ratios to phi, the weighting of resulting deviations by ladder position, the computation of a phi-anchored regularization penalty, and the incorporation of that penalty into training. Formal support, benchmark evidence, downstream applications, and additional implementation paths are all disclosed around that core, but do not replace it.

With FIG. 10 and the associated evidence architecture described, the detailed description has now introduced the overall system, the core penalty kernel, concrete extraction embodiments, training-loop integration, optional and alternative branches, implementation embodiments, validation workflow, and formal-support framework. The next section of the application can therefore move to the claims, followed by the abstract.

In some embodiments, characteristic scales are extracted from a single tensor source. In some embodiments, characteristic scales are extracted from multiple tensor sources and merged into a common ordered sequence before penalty computation. In some embodiments, separate ordered sequences are maintained for separate tensor classes, layers, heads, branches, channels, graph stages, or time windows, and separate penalty values are computed and then combined. The disclosed invention is therefore not limited to one extraction topology so long as the resulting regularization remains based on extracted characteristic scales, phi-ratio deviation, ladder-position-dependent weighting, and incorporation of the resulting penalty into training.

In some embodiments, the selected number of characteristic scales K is fixed for a model, layer, or run. In some embodiments, K is configurable. In some embodiments, K varies across layers, branches, or architectures. In preferred embodiments, K is at least 2 so that adjacent ratio computation is defined. In some embodiments, more than two characteristic scales are used so that multiple adjacent ratio terms contribute to the regularization penalty. The value of K can therefore be selected according to architecture, tensor type, computational budget, or validation preference without changing the disclosed kernel.

In some embodiments, extracted characteristic scales are conditioned before use in penalty computation. Such conditioning can include positivity enforcement, exclusion of zero-scale values, offsetting by a small positive constant, normalization, clipping, scaling, stable sorting, confidence-based filtering, deterministic tie handling, or another preprocessing operation that improves numerical stability or reproducibility. These operations should be understood as implementation details that can support practical make-and-use performance, not as changes to the identity of the invention.

In some embodiments, the disclosed regularizer is evaluated at one training location. In some embodiments, it is evaluated at multiple training locations. In some embodiments, different tensor classes use different extraction branches that feed a shared penalty kernel. In some embodiments, different penalty values are weighted, summed, averaged, or otherwise combined into a composite regularization contribution. Such multi-branch implementations remain within the scope of the disclosure so long as the composite regularization continues to be grounded in the disclosed phi-anchored scale-regularization mechanism.

In some embodiments, the disclosed regularizer is active throughout training. In some embodiments, the disclosed regularizer is activated or deactivated according to a schedule, phase, curriculum, trigger condition, pruning state, fine-tuning state, convergence state, or validation event. In some embodiments, one or more extraction branches are activated conditionally while the disclosed kernel remains unchanged. Such scheduling and control logic can be useful in practical deployment, but should be treated as optional implementation detail rather than as a required element of the core invention.

In some embodiments, one or more outputs associated with the disclosed regularizer are generated during or after training. Such outputs can include extracted scale values, ordered scale sequences, ratio-error summaries, ladder-coordinate summaries, weighting summaries, penalty summaries, task-performance summaries, validation reports, scale visualizations, conformity diagnostics, pruning-verification outputs, or trained-model artifacts. These outputs can be stored, displayed, transmitted, compared, or used in downstream workflows. However, the invention is not limited to output reporting, and such output products remain subordinate to the training-time regularization mechanism.

In some embodiments, the disclosed regularizer is implemented using software instructions stored on a non-transitory computer-readable medium. In some embodiments, the disclosed regularizer is embodied as a software library, a training-framework component, or an integrated training-system module. In some embodiments, the disclosed regularizer is executed on one or more general-purpose processors, graphics-processing units, field-programmable devices, accelerator resources, or specialized neural-processing resources. These implementation forms can vary without changing the regularization kernel disclosed herein.

In some embodiments, the present disclosure is further supported by worked examples and benchmark-oriented validation. In one image-classification example, a ResNet-18 model trained on CIFAR-10 using cross-entropy plus R_phi achieved benchmark-reported top-1 accuracy of 94.8% versus 93.2% without R_phi, with ratio error reduced to approximately 0.017 and with self-similar receptive-field organization observed in learned filters. In one reported example, receptive-field radii were observed at approximately 3, 5, 8, and 13 pixels, corresponding to a discrete approximation of a phi-ladder.

In one language-model example, a transformer or GPT-2/PTB-style benchmark using the disclosed regularizer produced benchmark-reported perplexity improvement relative to baseline conditions, and attention heads were observed to organize at token spans approximating a phi-ladder, including spans of approximately 5, 8, and 13 tokens in one reported configuration.

In one genomic feature-discovery example, a 1D convolutional model trained on DNA sequence data with the disclosed regularizer was reported to discover biologically meaningful scales including codon-related periodicity at approximately 3 bases and nearby ladder-related scales at approximately 5, 8, and 13 bases. In this way, the disclosed regularizer can support unsupervised or weakly supervised discovery of ladder-related structure in sequence data.

Additional worked examples can include vision-transformer embodiments, detector-event embodiments, edge-AI embodiments, and graph-neural-network embodiments. Such examples are useful for demonstrating implementation breadth and benchmark behavior, but remain subordinate to the core invention, which is the phi-anchored regularization mechanism itself.

In some embodiments, validation of the disclosed regularizer includes one or more benchmark-configured acceptance criteria. Example validation criteria can include ratio error less than 0.02 in a benchmark configuration, convergence of attention radii toward a phi-ladder, discovery of codon periodicity without labels in a genomic benchmark, receptive-field organization approximating ratios of 1:phi:phi\hat{ }2, and computational overhead below 1 percent in a selected benchmark configuration. These validation criteria should be understood as benchmark-oriented targets or acceptance criteria for specific embodiments rather than as universal limitations required in every implementation.

The disclosed embodiments preserve additional implementation variants, including embodiments in which characteristic scales are extracted from activations, weights, or attention patterns; embodiments in which FFT-based spectral extraction is used; embodiments in which local soft-peak refinement is used; embodiments in which continuous ladder weighting is used; embodiments in which quantized rung weighting is used; embodiments in which the canonical coupling X_opt=phi/pi is used; embodiments in which no tunable scalar coefficient multiplying R_phi is required; embodiments in which the penalty is used additively with another regularizer; and embodiments in which one or more machine-generated outputs report phi-ladder conformity or ratio-error behavior.

The present disclosure therefore sets out a broad but disciplined technical disclosure centered on the extraction of characteristic scales from model tensors, the computation of phi-referenced ratio deviation, the weighting of those deviations according to ladder position, the computation of a phi-anchored regularization penalty, and the incorporation of that penalty into model training. Preferred embodiments, optional embodiments, alternative embodiments, downstream applications, demonstrated examples, and prophetic examples are all disclosed in a manner that preserves future flexibility while maintaining a clear and defensible statement of the core invention.

What is claimed is:

1. A computer-implemented method of training a machine-learning model, the method comprising:
extracting, from one or more model tensors of the machine-learning model, an ordered sequence of characteristic scales;
computing, for adjacent characteristic scales in the ordered sequence, ratio-error values relative to a golden-ratio target phi;
computing ladder-position-dependent weighting values for the ratio-error values;
computing a regularization penalty from the ratio-error values and the ladder-position-dependent weighting values; and
updating parameters of the machine-learning model using a total loss that includes a task loss and the regularization penalty.

2. The method according to claim 1, wherein the ratio-error values are computed according to:
e_k=f_(k+1)/f_k−phi, where phi=(1+sqrt(5))/2, and where f_k denotes a k-th characteristic scale in the ordered sequence.

3. The method according to claim 1, wherein the ladder-position-dependent weighting values are computed using a ladder coordinate defined according to:
rho_k=log_phi(f_k/f_0), where f_0 is a baseline characteristic scale and log_phi(x)=ln(x)/ln(phi) for x>0.

4. The method according to claim 3, wherein the ladder-position-dependent weighting values are computed according to:
w_k=phi\hat{ }(−rho_k).

5. The method according to claim 1, wherein the regularization penalty is computed according to R_phi=X_opt*(1/(K−1))*sum_(k=0 to K−2) (w_k*e_k\hat{ }2), where K is a number of characteristic scales in the ordered sequence.

6. The method according to claim 5, wherein: X_opt=phi/pi.

7. The method according to claim 6, wherein the total loss is computed according to L=L_task +R_phi, and no tunable scalar coefficient multiplying R_phi is used.

8. The method according to claim 1, wherein extracting the ordered sequence of characteristic scales comprises extracting characteristic scales from each of a plurality of layers or tensor tap points, computing a respective regularization penalty for each extracted set of characteristic scales, and combining the respective regularization penalties into the total loss.

9. The method according to claim 1, wherein extracting the ordered sequence of characteristic scales comprises:
computing an FFT-based spectrum from a weight tensor, an activation tensor, or both; and
determining characteristic frequencies from the FFT-based spectrum.

10. The method according to claim 9, wherein determining the characteristic frequencies comprises selecting candidate peaks from the FFT-based spectrum and performing local soft-peak refinement within one or more local windows.

11. The method according to claim 1, wherein extracting the ordered sequence of characteristic scales comprises:
computing one or more expected token spans or attention radii from one or more attention distributions of a transformer model.

12. The method according to claim 1, wherein extracting the ordered sequence of characteristic scales comprises:
computing one or more non-zero eigenvalues of a graph Laplacian associated with a graph representation and using the one or more non-zero eigenvalues as at least part of the ordered sequence of characteristic scales.

13. The method according to claim 1, wherein extracting the ordered sequence of characteristic scales comprises:
determining one or more center scales of one or more wavelet channels and using the one or more center scales as at least part of the ordered sequence of characteristic scales.

14. The method according to claim 1, wherein the ladder-position-dependent weighting values are computed using a quantized rung index defined according to m_k=floor(rho_k), and the weighting values are computed according to w_k=phi\hat{ }(−m_k).

15. The method according to claim 14, wherein training is performed using straight-through estimation, stop-gradient treatment, or another discrete-compatible gradient treatment associated with the quantized rung index.

16. The method according to claim 1, wherein extracting the ordered sequence of characteristic scales comprises conditioning the characteristic scales to remain positive by excluding a zero-scale component, adding a positive offset, or both, and ordering the characteristic scales using a deterministic ordering policy before computation of the ratio-error values.

17. A machine-learning training system comprising:
a scale-extraction engine configured to extract, from one or more model tensors of a machine-learning model, an ordered sequence of characteristic scales;
a ratio-error engine configured to compute ratio-error values for adjacent characteristic scales relative to phi;
a ladder engine configured to compute ladder-position-dependent weighting values;
a penalty engine configured to compute a regularization penalty from the ratio-error values and the ladder-position-dependent weighting values; and
a loss-combination engine configured to combine the regularization penalty with a task loss for updating parameters of the machine-learning model, wherein the scale-extraction engine, ratio-error engine, ladder engine, penalty engine, and loss-combination engine are implemented by at least one processor and at least one memory storing instructions that cause performance of the recited operations.

18. The system according to claim 17, wherein the scale-extraction engine comprises at least one of: an FFT-based extraction engine, an attention-radius extraction engine, a graph spectral extraction engine, or a wavelet-scale extraction engine.

19. The system according to claim 17, wherein the penalty engine is configured to compute the regularization penalty according to R_phi=X_opt*(1/(K−1))*sum_k (w_k*e_k\hat{ }2), where K is a number of characteristic scales in the ordered sequence, and wherein the loss-combination engine is configured to compute a total loss according to L=L_task+R_phi, with X_opt fixed at phi/pi such that no tunable scalar coefficient multiplying R_phi is used.

20. A non-transitory computer-readable medium storing instructions that, when executed by one or more processors, cause the one or more processors to perform operations comprising:
extracting, from one or more model tensors of a machine-learning model, an ordered sequence of characteristic scales; computing ratio-error values for adjacent characteristic scales relative to phi; computing ladder-position-dependent weighting values; computing a regularization penalty from the ratio-error values and the ladder-position-dependent weighting values; combining the regularization penalty with a task loss to produce a total loss; and updating parameters of the machine-learning model using the total loss.
